(19) United States
(12) Patent Application Publication
(10) Pub. No.: US 2022/0059904 A1
(43) Pub. Date: Feb. 24, 2022

(54) MULTILAYER MEMBRANES, SEPARATORS, BATTERIES, AND METHODS

(71) Applicant: Ceigard, LLC, Charlotte, NC (US)

(72) Inventors: Eric R. White, Fort Mill, SC (US); Brian R. Stepp, Scottsdale, AZ (US); Geoffrey A. Tice, Rock Hill, SC (US)

(21) Appl. No.: 17/275,677

(22) PCT Filed: Sep. 16, 2019
(86) PCT No.: PCT/US2019/051210

§ 371 Date: Mar. 12, 2021

Related U.S. Application Data
(60) Provisional application No. 62/732,089, filed on Sep. 17, 2018.

(51) Int. Cl. H01M 50/457; B32B 27/08; B32B 27/32; B32B 27/18; H01M 50/417; H01M 50/403; H01M 50/491; H01M 50/494; B29B 11/10; B29B 11/14; H01G 11/52

(52) U.S. Cl. CPC H01M 50/457; B29K 2023/12; B32B 27/32; B32B 27/18; H01M 50/417; H01M 50/403; H01M 50/491; H01M 50/494; B29B 11/10; B29B 11/14; H01G 11/52; B32B 2250/242; B32B 2255/10; B32B 2307/514; B32B 2307/51; B32B 2307/581; B32B 2307/54; B32B 2307/732; B32B 2457/10; B32B 2457/16; B32B 2457/18; B32B 27/08

(57) ABSTRACT

In accordance with at least selected embodiments, the application, disclosure or invention relates to improved membranes, separator membranes, separators, battery separators, secondary lithium battery separators, multilayer membranes, multilayer separator membranes, multilayer separators, multilayer battery separators, multilayer secondary lithium battery separators, multilayer battery separators, electrochemical cells, batteries, capacitors, super capacitors, double layer super capacitors, fuel cells, lithium batteries, lithium ion batteries, secondary lithium batteries, and/or secondary lithium ion batteries, and/or methods for making and/or using such membranes, separator membranes, separators, battery separators, secondary lithium battery separators, electrochemical cells, batteries, capacitors, fuel cells, lithium batteries, lithium ion batteries, secondary lithium batteries, and/or secondary lithium ion batteries, and/or devices, vehicles or products including the same, and/or the like.

This Application is a 371 Application which claims priority to PCT/US2019/051210, filed Sep. 16, 2019, which claims benefit of and priority to U.S. Provisional Patent Application No. 62/732,089, filed Sep. 17, 2018, and is hereby incorporated by reference herein in its entirety.

### FIELD

In accordance with at least selected embodiments, the application, disclosure or invention relates to new or improved membranes, separator membranes, separators, battery separators, secondary lithium battery separators, multilayer membranes, multilayer separator membranes, multilayer separators, multilayer battery separators, multilayer secondary lithium battery separators, multilayer battery separators, batteries, capacitors, fuel cells, lithium batteries, lithium ion batteries, secondary lithium batteries, and/or secondary lithium ion batteries, and/or methods for making and/or using such membranes, separator membranes, separators, battery separators, secondary lithium battery separators, batteries, capacitors, fuel cells, lithium batteries, lithium ion batteries, secondary lithium batteries, and/or secondary lithium ion batteries, and/or devices, vehicles or products including the same, and/or methods for testing, quantifying, characterizing, and/or analyzing such membranes, separator membranes, separators, battery separators, and the like. In accordance with at least certain embodiments, the disclosure or invention relates to membrane layers, membranes or separator membranes, battery separators including such membranes, and/or related methods. In accordance with at least certain selected embodiments, the disclosure or invention relates to porous polymer membranes or separator membranes, battery separators including such membranes, and/or related methods. In accordance with at least particular embodiments, the disclosure or invention relates to microporous polyolefin membranes or separator membranes, microlayer membranes, multi-layer membranes including one or more microlayer or nanolayer membranes, battery separators including such membranes, and/or related methods. In accordance with at least certain particular embodiments, the disclosure or invention relates to microporous stretched polymer membranes or separator membranes having one or more exterior layers and/or interior layers, microlayer membranes, multi-layered microporous membranes or separator membranes having exterior layers and interior layers, some of which layers or sublayers are created by co-extrusion and then laminated together to form the membranes or separator membranes. In some embodiments, certain layers, microlayers or nanolayers can comprise a homopolymer, a copolymer, block copolymer, elastomer, and/or a polymer blend. In select embodiments, at least certain layers, microlayers or nanolayers can comprise a different or distinct polymer, homopolymer, copolymer, block copolymer, elastomer, and/or polymer blend. The disclosure or invention also relates to methods for making such a membrane, separator membrane, or separator, and/or methods for using such a membrane, separator membrane or separator, for example as a lithium battery separator. In accordance with at least selected embodiments, the application or invention is directed to multi-layered and/or microlayer porous or microporous membranes, separator membranes, separators, composites, electrochemical devices, and/or batteries, and/or methods of making and/or using such membranes, separators, composites, devices and/or batteries. In accordance with at least particular selected embodiments, the application or invention is directed to separator membranes that are multi-layered, in which one or more layers of the multi-layered structure is produced in a multi-layer or microlayer co-extrusion die with multiple extruders. The membranes, separator membranes, or separators can demonstrate improved shutdown, improved strength, improved dielectric breakdown strength, and/or reduced tendency to split.

### BACKGROUND

Many batteries, such as lithium ion batteries, incorporate monolayer or multilayer (two plus layers) membrane separators to separate electrodes, retain electrolyte, enhance charge transfer, and other roles. One conventional separator membrane design is a trilayer polyolefin-based separator by Celgard, LLC of Charlotte, N.C. While these conventional trilayer designs have been effective in many lithium and other batteries, especially in secondary lithium ion batteries, they may not work as effectively in certain newer battery designs, because in certain battery technologies they may not fully optimize a balance of strength and/or performance properties for use in newer applications of certain primary and/or secondary batteries, such as lithium ion rechargeable batteries. This is especially true as the battery separator requirements are becoming more demanding as customers want thinner and stronger battery separators. For example, a microporous trilayer membrane formed by coextruding the three layers can in some instances have reduced strength when made at thinner specifications. Separators formed by laminating monolayers can also in some instances fail to satisfy the ever-increasing demands of the new thinner and stronger separators in certain new applications.

Hence, there is a need for a new and improved multi-layered microporous membranes, base films, or battery separators having various improvements over prior or typical membranes, base films, or battery separators.

### SUMMARY

In accordance with at least selected embodiments, the application, disclosure or invention may address the prior needs, issues or problems, and may provide new or improved membranes, separator membranes, separators, battery separators, secondary lithium battery separators, multilayer (or multi-layer) membranes, multilayer separator membranes, multilayer separators, multilayer battery separators, multilayer secondary lithium battery separators, multilayer battery separators, batteries, capacitors, super capacitors, double layer super capacitors, fuel cells, lithium batteries, lithium ion batteries, secondary lithium batteries, and/or secondary lithium ion batteries, and/or methods for making and/or using such membranes, separator membranes, separators, battery separators, secondary lithium battery separators, batteries, capacitors, fuel cells, lithium batteries, lithium ion batteries, secondary lithium batteries, and/or secondary lithium ion batteries, and/or devices, vehicles or products including the same, and/or methods for testing, quantifying, characterizing, and/or analyzing such membranes, separator membranes, separators, battery separators, and the like. In accordance with at least certain embodiments, the disclosure or invention relates to membrane layers, membranes or separator membranes, battery separators including such membranes, and/or related methods. In accordance with at least certain selected embodiments, the disclosure or invention relates to porous polymer membranes or separator membranes, battery separators including such membranes, and/or related methods. In accordance with at least particular embodiments, the disclosure or invention relates to microporous polyolefin membranes or separator membranes, microlayer membranes, multi-layer membranes including one or more microlayer or nanolayer membranes, battery separators including such membranes, and/or related methods. In accordance with at least certain particular embodiments, the disclosure or invention relates to microporous stretched polymer membranes or separator membranes having one or more exterior layers and/or interior layers, microlayer membranes, multi-layered microporous membranes or separator membranes having exterior layers and interior layers, some of which layers or sublayers are created by co-extrusion and then laminated together to form the membranes or separator membranes. In some embodiments, certain layers, microlayers or nanolayers can comprise a homopolymer, a copolymer, block copolymer, elastomer, and/or a polymer blend. In select embodiments, at least certain layers, microlayers or nanolayers can comprise a different or distinct polymer, homopolymer, copolymer, block copolymer, elastomer, and/or polymer blend. The disclosure or invention also relates to methods for making such a membrane, separator membrane, or separator, and/or methods for using such a membrane, separator membrane or separator, for example as a lithium battery separator. In accordance with at least selected embodiments, the application or invention is directed to multi-layered and/or microlayer porous or microporous membranes, separator membranes, separators, composites, electrochemical devices, and/or batteries, and/or methods of making and/or using such membranes, separators, composites, devices and/or batteries. In accordance with at least particular selected embodiments, the application or invention is directed to separator membranes that are multi-layered, in which one or more layers of the multi-layered structure is produced in a multi-layer or microlayer co-extrusion die, e.g., a co-extrusion die with multiple extruders. The membranes, separator membranes, or separators can demonstrate improved shutdown, improved strength, improved dielectric breakdown strength, and/or reduced tendency to split.

In an aspect, a membrane described herein is a multilayered membrane. In some instances, the multilayered membrane comprises two outer layers, each outer layer comprising a polyolefin; and two or more inner layers, each inner layer comprising a polyolefin; wherein each of the outer layers is laminated to one inner layer and each of the two or more inner layers is laminated to at least one of the other inner layers. The polyolefin composition of each of the outer layers can comprise a polypropylene, a polypropylene blend, a polypropylene copolymer, a polyethylene, a polyethylene blend, a polyethylene copolymer, or any combination thereof. In some embodiments, the polyolefin composition of the outer layer comprises a polypropylene, a polypropylene blend, a polypropylene copolymer, or any combination thereof. In some embodiments, the polyolefin composition of each of the inner layers can comprise a polypropylene, a polypropylene blend, a polypropylene copolymer, a polyethylene, a polyethylene blend, a polyethylene copolymer, or any combination thereof.

In some instances, the two or more inner layers comprises a plurality of inner layers, such as two, three, four, five, six, or more inner layers. In some cases, the plurality of inner layers comprises two, three, or more layers. In one particular embodiment, the plurality of inner layers comprises three layers. In another embodiment, there are four inner layers, or five inner layers, or six inner layers, or seven inner layers, or eight inner layers, or nine inner layers, or ten inner layers. In preferred embodiments, there are two or more, or three or more inner layers so that 3 or more or four or more lamination interfaces are formed when the inner and outer layers are laminated together to form the microporous membrane.

Some new and improved multi-layered microporous membranes have been disclosed in, for example, WO 2017/083633, but as the industry becomes more demanding, even better products than these may be needed. The disclosure of WO 2017/083633 is incorporated by reference herein in its entirety.

The microporous membrane can in some instances be a penta-layered membrane comprising a first outer layer, a first inner layer, a second inner (or middle layer), a third inner layer, and a second outer layer. The first outer layer can be laminated to the first inner layer, the first inner layer can be laminated to the second inner (or middle) layer, the second inner (or middle) layer can be laminated to the third inner layer, and the third inner can be laminated to the second outer layer, forming four lamination interfaces between the five layers. The composition of the first and second outer layers and the second inner (or middle) layer can comprise a polypropylene, a polypropylene blend, a polypropylene copolymer, or any combination thereof. The composition of the first and second inner layers can comprise a polyethylene, a polyethylene blend, a polyethylene copolymer, or any combination thereof. In some embodiments, these layers may comprise a polyethylene, a polyethylene blend, a polyethylene copolymer, or any combination thereof.

In some embodiments, a multilayer membrane described herein comprises a penta-layered membrane comprising a structure of PP/PE/PP/PE/PP, where PP is a polypropylene, a polypropylene blend, a polypropylene copolymer, or any combination thereof, and PE is a polyethylene, a polyethylene blend, a polyethylene copolymer, or any combination thereof. In some instances, each of these penta-layers is laminated to their respective adjacent layers.

In some preferred embodiments, each of the layers in the multilayer membrane can comprise two, three, four, five, or six, or seven, or eight, or nine, or more sublayers. In some preferred instances, each layer comprises two, three, or more sublayers, and in some preferred instances, each layer comprises three sublayers. In some preferred embodiments, each of the sublayers of a layer can be coextruded together. Each sublayer can have a maximum average thickness of 6 μm or less, 5 μm or less, 4 μm or less, 3 μm or less, or 2 μm or less, or 1 μm or less.

In some instances, each layer in the multilayer membrane can have a maximum average thickness prior to stretching. For example, in some instances, each layer in the multilayer membrane can have a maximum average thickness of 1.2 mil or less, 1.1 mil or less, 1 mil or less, or 0.9 mil or less 0.8 mil or less, 0.75 mil or less, 0.5 mil or less, 0.4 mil or less, 0.3 mil or less, or 0.2 mil or less prior to stretching. Based on the number of layers in the multilayered membrane, the membrane as a maximum average thickness ranging from 1 to 50 microns. Each layer in the multilayer membrane can have a maximum average thickness of 33% or less, 32% or less, 31% or less, 30% or less, 29% or less, 28% or less, 27% or less, 26% or less, 25% or less, 24% or less, 23% or less, 22% or less, 21% or less, 20% or less, 19% or less, 18% or less, or 17% or less or less than a total average thickness of the membrane.

The laminated multilayer membrane can in some instances be uniaxially or biaxially stretched. In some embodiments, the multilayered membrane can be machine direction (MD) stretched, transverse direction (TD) stretched, or both MD and TD stretched. When the multilayered membrane is both MD and TD stretched, the stretching can be sequential or simultaneous. Moreover, in some instances the multilayered membrane can be calendered after stretching, such as being calendered after TD stretching.

In some embodiments, the multilayered membrane can comprise an additive, such as a functionalized polymer, an ionomer, a cellulose nanofiber, an inorganic particle, a lubricating agent, a nucleating agent, a cavitation promoter, a fluoropolymer, a cross-linker, a x-ray detectable material, a polymer processing agent, a high temperature melt index (HTMI) polymer, an electrolyte additive, an energy dissipative non-miscible additive, or any combination thereof. The additive can be part of a coating on the first outer layer, the second outer layer, or both layers. In some embodiments, the additive may be incorporated into one or more of the outer layers. When the outer layers comprise two or more sublayers, the additive may be incorporated into any one, some, or all of the sublayers.

In some embodiments, the multilayered membrane is a microporous multilayered membrane. In some instances, the first and second outer layers and the second inner (or middle) layer can have an average polypropylene pore size in the range of 0.01 to 1.0 microns and in some instances from 0.02 and 0.06 μm. In some instances, the first and third inner layers can have an average polyethylene pore size in the range of 0.01 to 1.0 microns and in some instances from 0.03 to 0.1 μm. Pore size may be measured using, for example, Aquapore or a water or mercury intrusion methodology.

The multilayered membrane can show improved physical properties compared to a similar tri-layer membrane. For example, in some embodiments, the multilayered membrane can have an increased or improved elasticity at or above 150° C. compared to, for example, a PP/PE/PP tri-layer microporous membrane or a (PP/PP/PP)/(PE/PE/PE)/(PP/PP/PP) multilayer “trilayer” microporous membrane having the same thickness, Gurley, porosity, and/or layer composition make-up as the membrane. In some embodiments, the multilayered membrane can have an increased or improved puncture resistance compared to, for example, a PP/PE/PP tri-layer microporous membrane or a (PP/PP/PP)/(PE/PE/PE)/(PP/PP/PP) multilayer “trilayer” microporous membrane having the same thickness, Gurley, porosity, and/or layer composition make-up as the membrane. The membrane has an increased or improved machine direction tensile at break compared to, for example, a PP/PE/PP tri-layer microporous membrane or a (PP/PP/PP)/(PE/PE/PE)/(PP/PP/PP) multilayer “trilayer” microporous membrane having the same thickness, Gurley, porosity, and/or layer composition make-up as the membrane. In some instances, the multilayered membrane has an increased or improved TD elongation compared to, for example, a PP/PE/PP tri-layer microporous membrane or a (PP/PP/PP)/(PE/PE/PE)/(PP/PP/PP) multilayer “trilayer” microporous membrane having the same thickness, Gurley, porosity, and/or layer composition make-up as the membrane.

In some instances for a lithium ion battery, an improvement comprises a multilayered membrane described herein. In a device, an improvement in some cases comprises a multilayered membrane described herein. In a textile, an improvement in some instances comprises a multilayered membrane described herein.

In another embodiment, a method of making a multilayer microporous membrane is described herein. The method comprises extruding a nonporous polypropylene precursor comprising a plurality of sublayers; extruding a nonporous polyethylene precursor comprising a plurality of sublayers; laminating the extruded polypropylene precursor layers with the extruded polyethylene precursor layers to form a first intermediate precursor having polyethylene and/or polypropylene layers, and in some embodiments, alternating polyethylene and polypropylene layers; simultaneously or singly/sequentially laminating a first outer layer comprising the extruded polypropylene or polyethylene precursors, and in preferred embodiments the polypropylene precursor, to a first surface of the intermediate precursor and laminating a second outer layer comprising the extruded polypropylene precursor or the polyethylene precursor, but in preferred embodiments the polypropylene precursor, to a second surface of the first intermediate precursor opposite the first surface to form a second intermediate precursor; annealing the second intermediate precursor to form an annealed multilayer membrane; stretching the annealed multilayer membrane to form a microporous multilayer membrane, wherein the stretching is uniaxial or biaxial; and optionally calendering the microporous multilayer membrane. In some preferred embodiments, calendering is performed.

In some embodiments, the extruded polypropylene precursor is a structure comprising a majority amount of polypropylene and the extruded polyethylene precursor is a structure comprising a majority amount of polyethylene. For example, a polypropylene precursor may have a structure “PP” or (PP/PP) or (PP/PE), or (PP/PE/PP) or (PP/PE/PP/PP), or (PP/PP/PE/PP/PP) or (PP/PE/PE/PP) as long as it contains a majority amount of polypropylene. A polyethylene precursor may have a structure PE (PE/PE), (PP/PE), (PE/PP/PE), (PE/PP/PP/PE), (PE/PE/PP/PP), etc., as long as it contains a majority amount of polyethylene. For example, a polypropylene or polyethylene precursor may have a structure (PP/PE), but for the polypropylene precursor the PP sublayer may be thicker than the PE sublayer and for the polyethylene precursor the PE sublayer may be thicker than the PP sublayer. The thicknesses of each layer of the precursors may be varied. For example, in some embodiments, the outer layers may be thinner than the inner layers, the inner layers may be thinner than the outer layers, the layer thicknesses may alternate between a thick and a thin, or all the layers may have different thicknesses.

In some embodiments, the first intermediate precursor comprises a trilayer multilayer membrane having a structure of PE/PP/PE. In some instances, the second intermediate precursor comprises a penta-layer membrane having a structure of PP/PE/PP/PE/PP. In each instance, each layer of the trilayer multilayer structure preferably has two or more sublayers. For example, PP is (PP/PP/PP), (PP/PE/PP), (PP/PP), or (PP/PE) where the “PP” is thicker, or a layer comprising three sublayers.

The uniaxial stretching can be in the machine direction or the transverse direction, and the biaxial stretching can be in the machine direction and transverse direction. In instances of biaxial stretching, the machine direction and transverse direction stretching can be sequential or simultaneous. In preferred embodiments, at least MD stretching is done to form pores.

The extruded precursors can in some instances comprise a plurality of sublayers. For example, the extruded polypropylene precursor can in some instances comprise two, three, four, or more sublayers, and the extruded polyethylene precursor can comprise two, three, four, or more sublayers. In some embodiments, the second intermediate precursor can comprise a penta-layer membrane having a structure of PP/PE/PP/PE/PP, where each layer comprises three sublayers. This structure is represented by (PP/PP/PP)/(PE/PE/PE)/(PP/PP/PP)/(PE/PE/PE)/(PP/PP/PP) or by (PP/PE/PP)/(PE/PP/PE)/(PP/PE/PP)/(PE/PP/PE)/(PP/PE/PP) or by, for example, (PP/PP/PE)/(PE/PP/PE)/(PE/PP/PE)/(PE/PP/PE)/(PE/PP/PP). In the second structure or the third structure, PP or PE may be the majority polymer in either of (PP/PE/PP) or (PE/PP/PE) or (PP/PE/PE) or (PE/PE/PP).

In some embodiments, the extruded polypropylene precursor and the polyethylene precursor are nonporous. Micropores can in some instances be formed in the uniaxial or biaxial stretching step. In preferred embodiments, pores or micropores may be formed in at least the MD stretching step of a uniaxial or biaxial process. In some cases, the method can further comprise a step of coating one or more of the first outer layer and the second outer layer.

In another aspect, a method for making a penta-layer microporous membrane is described herein comprising extruding a plurality of polypropylene membranes and polyethylene membranes; laminating one of the polyethylene membranes to a first side of a polypropylene membrane and another one of the polyethylene membranes to an opposite second side of the polypropylene membrane to form an inverted trilayer multilayer membrane having a structure of PE/PP/PE or (PE/PE/PE)/(PP/PP/PP)/(PE/PE/PE) laminating one of the polypropylene layers to one of the polyethylene membranes in the inverted trilayer multilayer membrane and another of the polypropylene layers to the other polyethylene membrane in the inverted trilayer multilayer membrane to form a penta-layer multilayer membrane having a structure of PP/PE/PP/PE/PP or (PP/PP/PP)/(PE/PE/PE)/(PP/PP/PP)/(PE/PE/PE)/(PP/PP/PP); annealing the penta-layer multilayer membrane; stretching the annealed multilayer membrane to form a microporous multilayer membrane, wherein the stretching is uniaxial or biaxial; and optionally calendering the microporous multilayer membrane. In some preferred embodiments, the stretching is biaxial. In some preferred embodiments,

In an embodiment, the microporous membrane made by the methods described herein comprises a battery separator. In some instances, the microporous membrane made by the methods described herein comprises a lithium ion battery separator. In some instances, the microporous membrane made by the methods described herein comprises a device. In some instances, the microporous membrane made by the methods described herein comprises a textile.

### BRIEF DESCRIPTION OF THE DRAWINGS

FIG. 1 is an SEM of a second pentalayer membrane according to some embodiments described herein.

FIG. 2 is an SEM of a second pentalayer membrane according to some embodiments described herein.

FIGS. 3a, 3b, and 3c is a schematic drawing of trilayer and pentalayer membranes according to some embodiments described herein.

FIG. 4 is a schematic drawing of trilayers according to some embodiments described herein.

FIG. 5 is a schematic drawing of trilayers according to some embodiments described herein.

FIG. 6 is a schematic drawing of pentalayers according to some embodiments described herein.

FIG. 7 includes SEM images of a first pentalayer described herein after various processing steps.

FIG. 8 is a graph showing puncture strength as a function of In (BW*Thickness) for exemplary membranes described herein.

### DETAILED DESCRIPTION

Embodiments described herein can be understood more readily by reference to the following detailed description and examples. Elements, apparatus and methods described herein, however, are not limited to the specific embodiments presented in the detailed description and examples. It should be recognized that these embodiments are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, such as 1.0 to 5.3, or 4.7 to 10.0, or 3.6 to 7.9.

All ranges disclosed herein are also to be considered to include the end points of the range, unless expressly stated otherwise. For example, a range of “between 5 and 10,” “from 5 to 10,” or “5-10” should generally be considered to include the end points 5 and 10.

Further, when the phrase “up to” is used in connection with an amount or quantity, it is to be understood that the amount is at least a detectable amount or quantity. For example, a material present in an amount “up to” a specified amount can be present from a detectable amount and up to and including the specified amount.

I. Multilayer Membranes (or Membranes Separators)

In an aspect, an improved multilayer membrane, membrane, or separator is disclosed. In some embodiments, a multilayer microporous membrane, membrane, or separator is disclosed. While the term “membrane” will be used throughout this specification for purposes of simplicity, the term should be understood to also refer to a “membrane” or “separator”.

In some embodiments, the multilayer membrane comprises two outer layers and a plurality of inner layers. The plurality of inner layers can comprise 2 or more, 3 or more, 4 or more, 5 or more, 6 or more, 7 or more, 8 or more, 9 or more 11 or more, 12 or more, 13 or more, 14 or more, 15 or more, 15 or more, 16 or more 17 or more, 18 or more, 19 or more, 20 or more, 21 or more, 22 or more, 23 or more, 24 or more, 25 or more, 26 or more, 27 or more, 28 or more, 29 or more, 30 or more, 40 or more, 50 or more, 60 or more, 70 or more, 80 or more, 90 or more, or 100 or more layers. The term “layer” comprises a layer having a maximum average thickness of 0.01 to 2.0, 25, or 3.0 mil prior to being stretched. In some embodiments, the maximum average thickness is 0.1 to 1.5, 2.0, 2.5, or 3.0 mil prior to being stretched or 0.2 to 1.5, 2.0, 2.5, or 3.0 mil prior to being stretched, or 0.2 to 1.2, 1.5, 2.0, 2.5, or 3.0 mil prior to being stretched. In some preferred embodiments, the maximum average thickness of the layer is 0.1 to 0.5, 1.0, 1.5, 2.0, 2.5, or 3.0 mil prior to being stretched.

Each layer can be mono-extruded, where the layer is extruded by itself, without any sublayers. Alternatively, each layer can comprise a plurality of co-extruded sublayers. In preferred embodiments, each layer comprises a plurality, or 2 or more, co-extruded sublayers. For example, a co-extruded bi-layer (having two sublayers), tri-layer (having three sublayers), or multi-layer (having two or more three or more or four or more sublayers) membrane are each collectively considered to be a “layer”. The number of sublayers in coextruded bi-layer is two, the number of layers in a co-extruded tri-layer is three, and the number of layers in a co-extruded multi-layer membrane will be two or more, three or more, four or more, five or more, and so on. The exact number of sublayers in a co-extruded layer is dictated by the die design and not necessarily the materials that are co-extruded to form the co-extruded layer. For example, a co-extruded bi-, tri-, or multi-sublayer membrane can be formed using the same material in each of the two, three, or four or more sublayers, and these sublayers will still be considered to be separate sublayers even though each sublayer is made of the same material. Each layer comprising the co-extruded bi-, tri-, or multi-sublayer membranes can have a pre-stretched thickness of 3.0 mil or less, 2.5 mil or less, 2.0 mil or less, 1.5 mil or less, 1.2 mil or less, 1.1 mil or less, 1 mil or less, or 0.9 mil or less 0.8 mil or less, 0.75 mil or less, 0.5 mil or less, 0.4 mil or less, 0.3 mil or less, or 0.2 mil or less prior to stretching.

In some embodiments, the multilayer microporous membrane or multilayer microporous membrane disclosed herein comprises two, three, four, or five or more co-extruded layers. Co-extruded layers are layers formed by a co-extrusion process. In some instances, the layers can be formed by the same or separate co-extrusion processes. The consecutive layers can be formed by the same co-extrusion process, or two or more layers can be coextruded by one process. Two or layers can be coextruded by a separate process, and the two or more layers formed by the one process can be laminated to the two or more layers formed by the separate process so that combined there are four or more consecutive coextruded layers. In some embodiments, the co-coextruded layers are formed by the same co-extrusion process. For example, two or more, or three or more, four or more, five or more, six or more, seven or more, eight or more, nine or more, ten or more, fifteen or more, twenty or more, twenty-five or more, thirty or more, thirty-five or more, forty or more, forty-five or more, fifty or more, fifty-five or more or sixty or more co-extruded layers can be formed by the same co-extrusion process. The extrusion process can also be performed by extruding two or more polymer mixtures, that can be the same or different, with or without a solvent. In some instances, the co-extrusion process is a dry process, such as Celgard® dry process, which does not use a solvent.

In some embodiments, the multilayer membrane described herein is made by forming a coextruded bi-layer (two coextruded layers), tri-layer (three coextruded layers), or multi-layer (two, three, or four or more co-extruded layers) membrane and then laminating the bi-layer, tri-layer, or multi-layer membrane to at least one or at least two other membranes. The other membranes can be a non-woven or woven membrane, mono-extruded membranes, or a co-extruded membranes. In some preferred embodiments, the other membranes are co-extruded membranes, including co-extruded membranes having the same number of co-extruded layers as the co-extruded bi-layer, tri-layer, or multi-layer membranes. Moreover, each of the co-extruded layers can comprise two, three, four, or more sublayers, as previously described herein.

Lamination of the bi-layer, tri-layer, or multilayer co-extruded membrane with at least one other monolayer membrane or a bi-layer, tri-layer, or multi-layer membrane can involve use of heat, pressure, or heat and pressure.

The polymers or co-polymers that can be used in the instant battery separator are those that are extrudable. Such polymers are typically referred to as thermoplastic polymers.

In some embodiments, one or more of the layers of the multilayer microporous membrane or multilayer membrane comprises a polymer or co-polymer or a polymer or co-polymer blend, a polyolefin or polyolefin blend. A polyolefin blend, as understood by one of ordinary skill in the art, can include a mixture of two or more different kinds of polyolefin, such as polyethylene and polypropylene, a blend of two or more of the same kind of polyolefin, wherein each polyolefin has a different property, such as an ultra-high molecular weight polyolefin and a low or ultra-low molecular weight polyolefin, or a mixture of a polyolefin and another type of polymer or co-polymer. An additive, agent, filler, and/or the like may also be added to the polymers or polymer blends described herein. For example, an elastomer, a lubricant, an antioxidant, a colorant, a cross-linker, and/or the like.

Polyolefins include, but are not limited to: polyethylene, polypropylene, polybutylene, polymethylpentene, copolymers thereof, and blends thereof. In some embodiments, the polyolefin can be an ultra-low molecular weight, a low-molecular weight, a medium molecular weight, a high molecular weight, or an ultra-high molecular weight polyolefin, such as a medium or a high weight polyethylene (PE) or polypropylene (PP). For example, an ultra-high molecular weight polyolefin can have a molecular weight of 450,000 (450 k) or above, e.g. 500 k or above, 650 k or above, 700 k or above, 800 k or above, 1 million or above, 2 million or above, 3 million or above, 4 million or above, 5 million or above, 6 million or above, etc. A high-molecular weight polyolefin can have a molecular weight in the range of 250 k to 450 k, such as 250 k to 400 k, 250 k to 350 k, or 250 k to 300 k. A medium molecular weight polyolefin can have a molecular weight from 150 to 250 k, such as 100 k, 125 k, 130 K, 140 k, 150 k to 225 k, 150 k to 200 k, 150 k to 200 k, etc. A low molecular weight polyolefin can have a molecular weight in the range of 100 k to 150 k, such as 100 k to 125 k. An ultra-low molecular weight polyolefin can have a molecular weight less than 100 k. The foregoing values are weight average molecular weights. In some embodiments, a higher molecular weight polyolefin can be used to increase strength or other properties of the microporous multilayer membranes or batteries comprising the same as described herein. In some embodiments, a lower molecular weight polymer, such as a medium, low, or ultra-low molecular weight polymer can be beneficial. For example, without wishing to be bound by any particular theory, it is believed that the crystallization behavior of lower molecular weight polyolefins can result in a microporous multilayer membrane having smaller pores resulting from at least an MD stretching process that forms the pores.

Exemplary thermoplastic polymers, blends, mixtures or copolymers other than polyolefin polymers, blends, or mixtures can include, but are not limited to: polyacetals (or polyoxymethylenes), polyamides, polyesters, polysulfides, polyvinyl alcohols, polyvinyl esters, and polyvinylidenes, such as polyvinylidene difluoride (PVDF), Poly(vinylidene fluoride-co-hexafluoropropylene) (PVDF:HFP), Polytetrafluoroethylene (PTFE), polyethylene oxide (PEO), Poly(vinyl alcohol) (PVA), Polyacrylonitrile (PAN), or the like. Polyamides (nylons) include, but are not limited to: polyamide 6, polyamide 66, Nylon 10, 10, polyphthalamide (PPA), co-polymers thereof, and blends thereof. Polyesters include, but are not limited to: polyester terephthalate, polybutyl terephthalate, copolymers thereof, and blends thereof. Polysulfides include, but are not limited to, polyphenyl sulfide, copolymers thereof, and blends thereof. Polyvinyl alcohols include, but are not limited to: ethylene-vinyl alcohol, copolymers thereof, and blends thereof. Polyvinyl esters include, but are not limited to, polyvinyl acetate, ethylene vinyl acetate, copolymers thereof, and blends thereof. Polyvinylidenes include, but are not limited to: fluorinated polyvinylidenes (such as polyvinylidene chloride, polyvinylidene fluoride), copolymers thereof, and blends thereof. Various materials can be added to the polymers. These materials are added, in some instances, to modify or enhance the performance or properties of an individual layer or the overall membrane. Such materials include, but are not limited to: Materials to lower the melting temperature of the polymer can be added. For example, when the multilayer membrane is a battery separator, the multi-layered separator includes a layer designed to close its pores at a predetermined temperature to block the flow of ions between the electrodes of a battery. This function is commonly referred to as shutdown.

In some embodiments, each layer or sublayer of each layer of the multilayer membrane comprises, consists of, or consists essentially of a different polymer or co-polymer or polymer or co-polymer blend. In some embodiments each layer comprises, consists of, or consists essentially of the same polymer or co-polymer or polymer or co-polymer blend. In some embodiments, alternating layers of the multilayer microporous membrane or the multilayer membrane comprise, consist of, or consist essentially of the same polymer or co-polymer or polymer or co-polymer blend. In other embodiments, some of the layers and/or sublayers of the multilayer membrane or microporous multilayer membrane comprise, consist of, or consist essentially of the same polymer or polymer blend and some do not.

In some embodiments, the layers or sublayers of the multilayer membrane comprise, consist of, or consist essentially of polyolefin (PO) such as PP or PE or PE+PP blends, mixtures, co-polymers, or the like, and further comprise other polymers (PY), additives, agents, materials, fillers, and/or particles (M), and/or the like can be added or used and can form layers or microlayers such as PP+PY, PE+PY, PP+M, PE+M, PP+PE+PY, PE+PP+M, PP+PY+M, PE+PY+M, PP+PE+PY+M, or blends, mixtures, co-polymers, and/or the like thereof.

Identical, similar, distinct, or different PP or PE or PE+PP polymers, homopolymers, copolymers, molecular weights, blends, mixtures, co-polymers, or the like can also be used. For example, identical, similar, distinct, or different molecular weight PP, PE, and/or PP+PE polymers, homopolymers, co-polymers, multi-polymers, blends, mixtures, and/or the like can be used in each layer or sublayers. As such, constructions can include various combinations and subcombinations of PP, PE, PP+PE, PP1, PP2, PP3, PE1, PE2, PE3, PP1+PP2, PE1+PE2, PP1+PP2+PP3, PE1+PE2+PE3, PP1+PP2+PE, PP+PE1+PE2, PP1/PP2, PP1/PP2/PP1, PE1/PE2, PE1/PE2/PP1, PE1/PE2/PE3, PP1+PE/PP2, or other combinations or constructions.

In some embodiments, one or more additives can be added to the outermost layers of the multilayer microporous membrane or the multilayer membrane to improve the properties thereof or the properties of the battery separator or battery comprising the same. The outermost layer or any sublayer, including the outermost sublayer, of the outermost layer can comprise PE, PP, or PE+PP in addition to the additive. For example, to improve pin removal (i.e., lower the coefficient of friction of the membrane or membrane), additives such as lithium stearate, calcium stearate, PE beads, siloxane, and polysiloxanes can be added.

In addition, particular polymers, co-polymer or polymer or co-polymer blends can be used in the outermost layers (such as a first outer layer and a second outer layer or the outermost sublayer or any other sublayer of these first and second outer layers) of the multilayer membrane to improve the properties thereof or the properties of a battery separator or battery comprising the same. For example, adding an ultra-high molecular weight polymer or co-polymer in the outermost layer can improve puncture strength.

In further embodiments additives to improve oxidation resistance can be added to the outermost layers of the multilayer microporous membrane or membranes. The additive can be an organic or inorganic additive or a polymeric or non-polymeric additive.

In some embodiments, the outermost layers of the multilayer membrane or membrane can comprise, consist of, or consist essentially of polyethylene, polypropylene, or a mixture thereof.

As described above, the multilayer membrane can comprise two outer layers (a first outer layer and a second outer layer) and a plurality of inner layers. The plurality of inner layers can be mono-extruded or co-extruded layers. A lamination barrier or interface can be formed between each of the inner layers and/or between each of the outer layers and one of the inner layers. A lamination barrier or interface is formed when two surfaces, such as two surfaces of different membranes or layers are laminated together using heat, pressure, or heat and pressure. In some embodiments, the layers of the membrane areas have the following non-limiting constructions: PP, PE, PP/PP, PP/PE, PE/PP, PE/PE, PP/PP/PP, PP/PP/PE, PP/PE/PE. PP/PE/PP, PE/PP/PE, PE/PE/PP, PP/PP/PP/PP, PP/PE/PE/PP, PE/PP/PP/PE, PP/PE/PP/PP, PE/PE/PP/PP, PE/PP/PE/PP, PP/PE/PE/PE/PP, PE/PP/PP/PP/PE, PP/PP/PE/PP/PP, PE/PE/PP/PP/PE/PE, PP/PE/PP/PE/PP, PP/PP/PE/PE/PP/PP, PE/PE/PP/PP/PE/PE, PE/PP/PE/PP/PE/PP, PP/PE/PP/PE/PP/PE, PP/PP/PP/PE/PP/PP/PP, PE/PE/PE/PP/PE/PE/PE, PP/PE/PP/PE/PP/PE/PP, PE/PP/PE/PP/PE/PP/PE, PE/PP/PE/PP/PE/PP/PE/PP, PP/PE/PP/PE/PP/PE/PP/PE, PP/PP/PE/PE/PP/PP/PE/PE, PP/PE/PE/PE/PE/PE/PE/PP, PE/PP/PP/PP/PP/PP/PP/PE, PP/PP/PE/PE/PEPE/PP/PP, PP/PP/PP/PP/PE/PE/PE/PE, PP/PP/PP/PP/PE/PP/PP/PP/PP, PE/PE/PE/PE/PP/PE/PE/PE/PE, PP/PE/PP/PE/PP/PE/PP/PE/PP, PE/PP/PE/PP/PE/PP/PE/PP/PE, PE/PE/PE/PE/PE/PP/PP/PP/PP, PP/PP/PP/PP/PP/PE/PE/PE/PE, PP/PP/PP/PP/PP/PE/PE/PE/PE/PE, PE/PE/PE/PE/PE/PP/PP/PP/PP/PP, PP/PE/PP/PE/PP/PE/PP/PE/PP/PE, PE/PP/PE/PP/PE/PP/PE/PP/PE/PP, PE/PP/PP/PP/PP/PP/PP/PP/PP/PP/PE, PP/PE/PE/PE/PE/PE/PE/PE/PE/PE/PP, PP/PP/PE/PE/PP/PP/PE/PE/PP/PP, PE/PE/PP/PP/PP/PP/PP/PP/PP/PE/PE, PP/PP/PP/PE/PE/PP/PP/PP/PP/PE, PE/PE/PE/PP/PP/PE/PE/PE/PP/PP. For purposes of reference herein PE denotes a single layer (which in preferred embodiments includes sublayers) within the multilayer membrane that comprises, consists of, or consists essentially of PE. Similarly, PP denotes a single layer (which in preferred embodiments includes sublayers) within the multilayer membrane that comprises, consists of, or consists essentially of PP.

The PE or PP composition in each of the different layers can be the same or different type of PE or PP compositions in the other layers. For example, a coextruded precursor can have a structure (PP1/PP2/PP3), (PP3/PP2/PP1), (PP3/PP3/PP2/PP1/PP1), (PP3/PP3/PP2/PP2/PP1/PP1), (PP3/PP3/PP3/PP2/PP2/PP2/PP1/PP1/PP1), and so on. PP1 may be made of a homopolymer PP and an additive to modify the surface coefficient of friction, including any anti-slip or anti-block additives like polysiloxane or siloxane. PP2 can be made of the same or a different PP homopolymer than PP1 and a copolymer of PP. the PP copolymer can be any propylene-ethylene or ethylene-propylene random copolymer, block copolymer, or elastomer. PP3 can be made of the same or a different homopolymer PP than PP1 and PP2 and also includes an additive to modify surface coefficient of friction, which can be the same or different from that used in PP1. Stated differently, a multilayer membrane with a general structure of PP/PE/PP/PE/PP can comprise PP1/PE1/PP2/PE2/PP3, where each of the PP layers has a different polypropylene composition than the other two PP layers, and likewise for the two PE layers.

In another embodiment, the coextruded precursor can have a structure (PP1/PP2/PP3), (PP3/PP2/PP1), (PP3/PP3/PP2/PP1/PP1), (PP3/PP3/PP2/PP2/PP1/PP1), (PP3/PP3/PP3/PP2/PP2/PP2/PP1/PP1/PP1), and so on. PP1 can be any polypropylene blend. PP2 can be made of any polypropylene block co-polymer, including those described herein. PP3 can be made of the same or a different polypropylene-block co-polymer than that used in PP2.

The individual layers in the multilayer membrane can comprise a plurality of sublayers, which can be formed by co-extrusion or combining, e.g., by lamination, the individual mono-extruded sublayers to form the individual layer of the multilayer membrane. Using a multilayer membrane having a structure of PP/PE/PP/PE/PP, each individual PP or PE layer can comprise two or more co-extruded sublayers. For example, when each individual PP or PE layer comprises three sublayers, each individual PP layer can be expressed as PP=(PP1,PP2,PP3) and each individual PE layer can be expressed as PE=(PE1,PE2,PE3). Thus, the structure of PP/PE/PP/PE/PP can be expressed as (PP1,PP2,PP3)/(PE1,PE2,PE3)/(PP1,PP2,PP3)/(PE1,PE2,PE3)/(PP1,PP2,PP3) or as (PP1/PP2/PP3)/(PE1/PE2/PE3)/(PP1/PP2/PP3)/(PE1/PE2/PE3)/(PP1/PP2/PP3). The composition of each of the PP1, PP2, and PP3 sublayers can be the same, or each sublayer can have a different polypropylene composition than one or both of the other polypropylene sublayers. Similarly, composition of each of the PE1, PE2, and PE3 sublayers can be the same, or each sublayer can have a different polyethylene composition than one or both of the other polyethylene sublayers. This principle applies to other multilayer membranes having more or less layers that the above-described exemplary penta-layer membrane. The improved or inventive penta-layer multilayer membrane described above has four lamination interfaces. A similar six-layer multilayer membrane would have 5 lamination interfaces and a similar four layer multilayer membrane would have three lamination surfaces. It is hypothesized herein that a multilayer membrane having 3 or more, and in some preferred embodiments 4 or more lamination interfaces, will have improved properties. For example they will have improved properties compared to certain microlayer three layer (or trilayer) multilayer membranes that have only two lamination interfaces or compared to a traditional trilayer.

The maximum average thickness of each sublayer in a layer can less than 50 microns, less than 40 microns, less than 30 microns, less than 25 microns, less than 20 microns, less than 19 microns, less than 18 microns, less than 17 microns, less than 16 microns, less than 15 microns, less than 14 microns, less than 13 microns, less than 12 microns, less than 11 microns, less than 10 microns, less than 9 microns, less than 8 microns, less than 7 microns, less than 6 microns, less than 5 microns, less than 4 microns, less than 3 microns, less than 2 microns, or less than 1 micron. The thickness of each layer of the microporous membrane can be 50 microns, less than 40 microns, less than 30 microns, less than 25 microns, less than 20 microns, less than 19 microns, less than 18 microns, less than 17 microns, less than 16 microns, less than 15 microns, less than 14 microns, less than 13 microns, less than 12 microns, less than 11 microns, less than 10 microns, less than 9 microns, less than 8 microns, less than 7 microns, less than 6 microns, less than 5 microns, less than 4 microns, less than 3 microns, less than 2 microns, or less than 1 micron. The thickness of the microporous membrane can be 50 microns, less than 40 microns, less than 30 microns, less than 25 microns, less than 20 microns, less than 19 microns, less than 18 microns, less than 17 microns, less than 16 microns, less than 15 microns, less than 14 microns, less than 13 microns, less than 12 microns, less than 11 microns, less than 10 microns, less than 9 microns, less than 8 microns, less than 7 microns, less than 6 microns, less than 5 microns, less than 4 microns, less than 3 microns, less than 2 microns, or less than 1 micron. This is the thickness of the multilayer membranes or membranes before any coating or treatment is applied thereto.

Microporous as used herein means that the average pore size of the membrane, or coating is 2 microns or less, 1 micron or less, 0.9 microns or less, 0.8 microns or less, 0.7 microns or less, 0.6 microns or less, 0.5 microns or less, 0.4 microns or less, 0.3 microns or less, 0.2 microns or less, and 0.1 microns or less, 0.09 microns or less, 0.08 microns or less, 0.07 microns or less, 0.06 microns or less, 0.05 microns or less, 0.04 microns or less, 0.03 microns or less, 0.02 microns or less, or 0.01 microns or less. In some embodiments, pores can be formed, for example, by performing a stretching process on a precursor membrane, such as is done in the Celgard® dry process.

In some embodiments, where one or more layers of the multilayer membrane comprises, consists of, or consists essentially of microporous PE, the average pore size in the PE layer is between 0.03 and 0.1, between 0.05 to 0.09, 0.05 to 0.08, 0.05 to 0.07, or 0.05 to 0.06.

In some embodiments, where one or more layers of the multilayer membrane comprises, consists of, or consists essentially of microporous PP, the average pore size in the PP layer is between 0.02 to 0.06, 0.03 to 0.05, and more 0.04 to 0.05 or 0.03 to 0.04.

In instances where the multilayer microporous membrane or membrane comprises layers comprising, consisting of, or consisting essentially of PP and comprises other layers comprising, consisting of, or consisting essentially of PE, the average pore size of the PP layers is smaller than that of the PE layers.

The microporous multilayer membrane can have any Gurley not inconsistent with the objectives of this disclosure, such as a Gurly that is acceptable for use as a battery separator. In some embodiments, the microporous multilayer membrane or membrane described herein has a JIS Gurley (s/100 cc) of 150 or more, 160 or more, 170 or more, 180 or more, 190 or more, 200 or more, 210 or more, 220 or more, 230 or more, 240 or more, 250 or more, 260 or more, 270 or more, 280 or more, 290 or more, 300 or more, 310 or more, 320 or more, 330 or more, 340 or more, or 350 or more. Sometimes Gurley may be less than 150 s/100 cc and sometimes it may be as high as 500 s/100 cc or more. As long as the Gurley allows the membrane to function as a battery separator, Gurley is not so limited.

The porosity of the microporous multilayer membrane can be any porosity not inconsistent with the goals of this disclosure. For example, any porosity that could form an acceptable battery separator is acceptable. In some embodiments, the porosity of the membrane or membrane can be from 10 to 60%, from 20 to 60%, from 30 to 60%, or from 40 to 60%. Sometimes the porosity of the membrane may be 65% or more or 70% or more. It is not so limited as long as the membrane functions as a battery separator.

The microporous multilayer membrane or membrane can have a puncture strength, uncoated, of 200 gf or more, 210 gf or more, 220 gf or more, 230 gf or more, 240 gf or more, 250 gf or more, 260 gf or more, 270 gf or more, 280 gf or more, 290 gf or more, 300 gf or more, 310 gf or more, 320 gf or more, 330 gf or more, 340 gf or more, 350 gf or more, or as high as 400 gf or more. In some embodiments, puncture strength may be lower than 200 gf, especially for thinner membranes, and in some embodiments, the puncture may be as high as 500 gf or higher.

In some embodiments, the multilayer microporous membrane described herein can comprise one or more additives in at least one layer of the multilayer microporous membrane. In some embodiments, at least one layer or sublayer of the multilayer microporous membranes comprises more than one, such as two, three, four, five, or more, additives. Additives can be present in one or both of the outermost layers of the multilayer microporous membrane, in one or more inner layers, in all of the inner layers, or in all of the inner and both of the outermost layers. In some embodiments, additives can be present in one or more outermost layers and in one or more innermost layers. In such embodiments, over time, the additive can be released from the outermost layer or layers and the additive supply of the outermost layer or layers can be replenished by migration of the additive in the inner layers to the outermost layers. In some embodiments, each layer of the multilayer microporous membrane can comprise a different additive or combination of additives than an adjacent layer or each layer of the multilayer microporous membrane.

In some embodiments, the additive is, comprises, consists of, or consists essentially of a functionalized polymer. As understood by one of ordinary skill in the art, a functionalized polymer is a polymer with functional groups coming off of the polymeric backbone. Exemplary functional groups include: In some embodiments, the functionalized polymer is a maleic anhydride functionalized polymer. In some embodiments the maleic anhydride modified polymer is a maleic anhydride homo-polymer polypropylene, copolymer polypropylene, high density polypropylene, low-density polypropylene, ultra-high density polypropylene, ultra-low density polypropylene, homo-polymer polyethylene, copolymer polyethylene, high density polyethylene, low-density polyethylene, ultra-high density polyethylene, ultra-low density polyethylene,

In some embodiments, the additive comprises, consists of, or consists essentially of an ionomer. An ionomer, as understood by one of ordinary skill in the art is a copolymer containing both ion-containing and non-ionic repeating groups. Sometimes the ion-containing repeating groups can make up less than 25%, less than 20%, or less than 15% of the ionomer. In some embodiments, the ionomer can be a Li-based, Na-based, or Zn-based ionomer.

In some embodiments, the additives comprises cellulose nanofiber.

In some embodiments, the additive comprises inorganic particles having a narrow size distribution. For example, the difference between D10 and D90 in a distribution is less than 100 nanometers, less than 90 nanometers, less than 80 nanometers, less than 70 nanometers, less than 60 nanometers, less than 50 nanometers, less than 40 nanometers, less than 30 nanometers, less than 20 nanometers, or less than 10 nanometers. In some embodiments, the inorganic particles are selected from at least one of SiO₂, TiO₂, or combinations thereof.

In some embodiments, the additive can comprise, consists of, or consist essentially of a lubricating agent. The lubricating agent or lubricant described herein is not so limited. As understood by one of ordinary skill in the art, a lubricant is a compound that acts to reduce the frictional force between a variety of different surfaces, including the following: polymer:polymer; polymer:metal; polymer; organic material; and polymer:inorganic material. Specific examples of lubricating agents or lubricants as described herein are compounds comprising siloxy functional groups, including siloxanes and polysiloxanes, and fatty acid salts, including metal stearates.

Compounds comprising two or more, three or more, four or more, five or more, six or more, seven or more, eight or more, nine or more, or ten or more siloxy groups can be used as the lubricant described herein. Siloxanes, as understood by those in the art, are a class of molecules with a backbone of alternating silicon atom (Si) and oxygen (O) atoms, each silicon atom can have a connecting hydrogen (H) or a saturated or unsaturated organic group, such as —CH3 or C2H5. Polysiloxanes are a polymerized siloxanes, usually having a higher molecular weight. In some embodiments described herein, the polysiloxanes can be high molecular weight, such as ultra-high molecular weight polysiloxanes. In some embodiments, high and ultra-high molecular weight polysiloxanes can have weight average molecular weights ranging from 500,000 to 1,000,000.

The fatty acid salts described herein are also not so limited and can be any fatty acid salt that acts as a lubricant. The fatty acid of the fatty acid salt can be a fatty acid having between 12 to 22 carbon atoms. For example, the metal fatty acid can be selected from the group consisting of: Lauric acid, myristic acid, palmitic acid, stearic acid, oleic acid, linoleic acid, linolenic acid, palmitoleic acid, behenic acid, erucic acid, and arachidic acid. The metal can be any metal not inconsistent with the objectives of this disclosure. In some instances, the metal is an alkaline or alkaline earth metal, such as Li, Be, Na, Mg, K, Ca, Rb, Sr, Cs, Ba, Fr, and Ra. In some embodiments, the metal is Li, Be, Na, Mg, K, or Ca.

The fatty acid salt can be lithium stearate, sodium stearate, lithium oleate, sodium oleate, sodium palmitate, lithium palmitate, potassium stearate, or potassium oleate.

The lubricant, including the fatty acid salts described herein, can have a melting point of 200° C. or above, 210° C. or above, 220° C. or above, 230° C. or above, or 240° C. or above. A fatty acid salt such as lithium stearate (melting point of 220° C.) or sodium stearate (melting point 245 to 255° C.) has such a melting point. A fatty acid salt such as calcium stearate (melting point 155° C.) does not. The inventors of this application have found that calcium stearate is less ideal, from a processing standpoint, than other fatty acid metal salts, such as metal stearates, having higher melting points. Particularly, it has been found that calcium stearate could not be added in amounts above 800 ppm without what has been termed a “snowing effect” where wax separates and gets everywhere during a hot extrusion process. Without wishing to be bound by any particular theory, using a fatty acid metal salt with a melting point above the hot extrusion temperatures is believed to solve this “snowing” problem. Fatty acid salts having higher melting points than calcium stearate, particularly those with melting points above 200° C., can be incorporated in amounts above 1% or 1,000 ppm, without “snowing.” Amounts of 1% or above have been found to be important for achieving desired properties such as improved wettability and pin removal improvement.

In some embodiments, the additive can comprise, consist of, or consist essentially of one or more nucleating agents. As understood by one of ordinary skill in the art, nucleating agents are, in some embodiments, materials, inorganic materials, that assist in, increase, or enhance crystallization of polymers, including semi-crystalline polymers.

In some embodiments, the additive can comprise, consist of, or consist essentially of cavitation promoters. Cavitation promoters, as understood by those skilled in the art, are materials that form, assist in formation of, increase formation of, or enhance the formation of bubbles or voids in the polymer.

In some embodiments, the additive can comprise, consist of, or consist essentially of a fluoropolymer. The fluoropolymer is not so limited and in some embodiments is PVDF.

In some embodiments, the additive can comprise, consist of, or consist essentially of a cross-linker.

In some embodiments, the additive can comprise, consist of, or consist essentially of an x-ray detectable material. The x-ray detectable material is not so limited and can be any material, for example, those disclosed in U.S. Pat. No. 7,662,510, which is incorporated by reference herein in its entirety. Suitable amounts of the x-ray detectable material or element are also disclosed in the '510 patent, but in some embodiments, up to 50 weight %, up to 40 weight %, up to 30 weight %, up to 20 weight %, up to 10 weight %, up to 5 weight %, or up to 1 weight % based on the total weight of the microporous membrane or membrane can be used. In an embodiment, the additive is barium sulfate.

In some embodiments, the additive can comprise, consist of, or consist essentially of a lithium halide. The lithium halide can be lithium chloride, lithium fluoride, lithium bromide, or lithium iodide. The lithium halide can be lithium iodide, which is both ionically conductive and electrically insulative. In some instances, a material that is both ionically conductive and electrically insulative can be used as part of a battery separator.

In some embodiments, the additive can comprise, consist of, or consist essentially of a polymer processing agent. As understood by those skilled in the art, polymer processing agents or additives are added to improve processing efficiency and quality of polymeric compounds. In some embodiments, the polymer processing agent can be antioxidants, stabilizers, lubricants, processing aids, nucleating agents, colorants, antistatic agents, plasticizers, or fillers.

In some embodiments, the additive can comprise, consist of, or consist essentially of a high temperature melt index (HTMI) polymer. The HTMI polymer is not so limited and can be at least one selected from the group consisting of PMP, PMMA, PET, PVDF, Aramid, syndiotactic polystyrene, and combinations thereof.

In some embodiments, the additive can comprise, consist of, of consist essentially of an electrolyte additive. Electrolyte additives as described herein are not so limited as long as the electrolyte is consistent with the stated goals herein. The electrolyte additive can be any additive typically added by battery makers, particularly lithium battery makers to improve battery performance. Electrolyte additives preferably should also be capable of being combined, such as miscible, with the polymers used for the polymeric microporous membrane or compatible with the coating slurry. Miscibility of the additives can also be assisted or improved by coating or partially coating the additives. For example, exemplary electrolyte additives are disclosed in A Review of Electrolyte Additives for Lithium-Ion Batteries, J. of Power Sources, vol. 162, issue 2, 2006 pp. 1379-1394, which is incorporated by reference herein in its entirety. In some embodiments, the electrolyte additive is at least one selected from the group consisting of a solid electrolyte interphase (SEI) improving agent, a cathode protection agent, a flame retardant additive, LiPF₆ salt stabilizer, an overcharge protector, an aluminum corrosion inhibitor, a lithium deposition agent or improver, or a solvation enhancer, an aluminum corrosion inhibitor, a wetting agent, and a viscosity improver. In some embodiments the additive can have more than one property, such as it can be a wetting agent and a viscosity improver.

Exemplary SEI improving agents include VEC (vinyl ethylene carbonate), VC (vinylene carbonate), FEC (fluoroethylene carbonate), LiBOB (Lithium bis(oxalato) borate). Exemplary cathode protection agents include N,N′-dicyclohexylcarbodiimide, N,N-diethylamino trimethylsilane, LiBOB. Exemplary flame-retardant additives include TTFP (tris(2,2,2-trifluoroethyl) phosphate), fluorinated propylene carbonates, MFE (methyl nonafluorobuyl ether). Exemplary LiPF₆ salt stabilizers include LiF,TTFP (tris(2,2,2-trifluoroethyl) phosphite), 1-methyl-2-pyrrolidinone, fluorinated carbamate, hexamethyl-phosphoramide. Exemplary overcharge protectors include xylene, cyclohexylbenzene, biphenyl, 2, 2-diphenylpropane, phenyl-tert-butyl carbonate. Exemplary Li deposition improvers include AlI₃, SnI₂, cetyltrimethylammonium chlorides, perfluoropolyethers, tetraalkylammonium chlorides with a long alkyl chain. Exemplary ionic salvation enhancer include 12-crown-4, TPFPB (tris(pentafluorophenyl)). Exemplary A1 corrosion inhibitors include LiBOB, LiODFB, such as borate salts. Exemplary wetting agents and viscosity dilutersinclude cyclohexane and P₂O₅. In some embodiments, the electrolyte additive is air stable or resistant to oxidation. A battery separator comprising the electrolyte additive disclosed herein can have a shelf life of weeks to months, e.g. one week to 11 months.

In some embodiments, the additive can comprise, consist of, or consist essentially of an energy dissipative non-miscible additive. Non-miscible means that the additive is not miscible with the polymer used to form the layer of the multilayer microporous membrane or membrane that contains the additive.

In some embodiments, the membrane or membrane has or exhibits increased or improved puncture strength compared to a tri-layer microporous membrane or a three layer (trilayer) multilayer microporous membrane. For example, the puncture strength may be above 250 g, above 260 g, above 270 g, above 280 g, above 290 g, above 300 g, or above 310 g. In preferred embodiments the puncture is greater than or equal to 300 g or greater than or equal to 310 g. The multilayer membrane described herein may also have improved MD shrinkage at 120° C. for 1 hour compared to a tri-layer microporous membrane or a three layer (trilayer) multilayer microporous membrane. For example, MD shrinkage at 120° C. for 1 hour may be less than 25%, less than 24%, less than 23%, less than 22%, less than 21%, or less than 20%. In preferred embodiments it is less than 24% or less than 20%. It can be less than 15%. The multilayer membrane described herein may also have improved MD tensile @ break. For example, the MD tensile at break may be greater than 900 kg/cm², or greater than 1,000 kg/cm² or greater than 1,100 kg/cm². These properties are of the membrane itself, i.e., without a coating or other treatment. In some embodiments, these properties may be exhibited in a TD stretched product.

In some embodiments, at least one layer of the multilayer membrane or membrane described herein comprises a polymeric additive. The polymeric additive is added in an amount less than the main polymer that the membrane is made up of. For example, in some embodiments, the principle polymer can be a polyolefin. This is another way of saying that at least one layer of the multilayer membrane or membrane described herein comprises or is made up of a polymeric blend. In some embodiments, the layer can comprise or be made up of a polymeric or polymer blend and one or more of the other additives described herein.

In some embodiments, the layer comprising the polymer blend is an outer layer, such as a first outer layer or an opposite second outer layer. In some instances, both a first outer layer and a second outer layer comprise a polymer blend. In some embodiments, an inner layer comprises a polymer blend. In some instances at least one inner and at least one outer layer comprises a polymer blend, and in some embodiments, all of the inner layers and all of the outer layers comprise a polymer blend.

In some embodiments, the polymer blend comprises, consists of, or consists essentially of at least two different polyolefins, such as at least two different polyethylenes, at least two two different polypropylenes, or a combination of at least one polyethylene and one polypropylene. In some embodiments, the polymer blend comprises, consists of, or consists essentially of a polyolefin and a non-polyolefin, i.e., a polymer that is not a polyolefin.

In some embodiments, each layer of the multilayer membrane or membrane has a different compositions than the layers adjacent to them. For example, one layer can comprise a polymer blend of two different polyolefins, and one adjacent layer can comprise a polymer blend of a polyolefin and a non-polyolefin, and the other adjacent does not comprise a polymer blend.

The multilayer membrane can be stretched in a machine direction (MD) to make the multilayer membrane microporous. In some instances, the microporous multilayer membrane is produces by transverse direction (TD) stretching of the MD stretched microporous multilayer membrane. In addition to a sequential MD-TD stretching, the multilayer membrane can also simultaneously undergo a biaxial MD-TD stretching. Moreover, the simultaneous or sequential MD-TD stretched microporous multilayer membrane can be followed by a subsequent calendering step to reduce the membrane's thickness, reduce roughness, reduce percent porosity, increase TD tensile strength, increase uniformity, and/or reduce TD splittiness. In some embodiments, the multilayer membrane is TD stretched 1×, 2×, 3×, 4×, 5×, 6×, 7×, 8×, 9×, 10×, or more than 10×.

In an embodiment, a multilayer membrane can be manufactured using an exemplary process that includes stretching and a subsequent calendering step such as a machine direction stretching followed by transverse direction stretching (with or without machine direction relax) and a subsequent calendering step as a method of reducing the thickness of such a stretched membrane, for example, a multilayer porous membrane, in a controlled manner, to reduce the percent porosity of such a stretched membrane, for example, a multilayer porous membrane, in a controlled manner, and/or to improve the strength, properties, and/or performance of such a stretched membrane, for example, a multilayer porous membrane, in a controlled manner, such as the puncture strength, machine direction and/or transverse direction tensile strength, uniformity, wettability, coatability, runnability, compression, spring back, tortuosity, permeability, thickness, pin removal force, mechanical strength, surface roughness, hot tip hole propagation, and/or combinations thereof, of such a stretched membrane, for example, a multilayer porous membrane, in a controlled manner, and/or to produce a unique structure, pore structure, material, membrane, base film, and/or separator.

In some instances, the TD tensile strength of the multilayer membrane can be further improved by the addition of a calendering step following TD stretching. The calendering process typically involves heat and pressure that can reduce the thickness of a porous membrane. The calendering process step can recover the loss of MD and TD tensile strength caused by TD stretching. Furthermore, the increase observed in MD and TD tensile strength with calendering can create a more balanced ratio of MD and TD tensile strength which can be beneficial to the overall mechanical performance of the multilayer membrane.

The calendering process can use uniform or non-uniform heat, pressure and/or speed to selectively densify a heat sensitive material, to provide a uniform or non-uniform calender condition (such as by use of a smooth roll, rough roll, patterned roll, micro pattern roll, nano pattern roll, speed change, temperature change, pressure change, humidity change, double roll step, multiple roll step, or combinations thereof), to produce improved, desired or unique structures, characteristics, and/or performance, to produce or control the resultant structures, characteristics, and/or performance, and/or the like. In an embodiment, a calendering temperature of 50° C. to 70° C. and a line speed of 40 to 80 ft/min can be used, with a calendering pressure of 50 to 200 psi. The higher pressure can in some instances provide a thinner separator, and the lower pressure provide a thicker separator. These exemplary processing conditions are all non-limiting.

In some embodiments, one or more coating layers can be applied to one or two sides of the multilayer membrane. In some embodiments, one or more of the coatings can be a ceramic coating comprising, consisting of, or consisting essentially of a polymeric binder and organic and/or inorganic particles. In some embodiments, only a ceramic coating is applied to one or both sides of the microporous membrane. In other embodiments, a different coating can be applied to the microporous membrane before or after the application of the ceramic coating. The different additional coating can be applied to one or both sides of the membrane or film also. In some embodiments, the different polymeric coating layer can comprise, consist of, or consist essentially of at least one of polyvinylidene difluoride (PVdF) or polycarbonate (PC).

In some embodiments, the thickness of the coating layer is less than about 12 μm, sometimes less than 10 μm, sometimes less than 9 μm, sometimes less than 8 μm, sometimes less than 7 μm, and sometimes less than 5 μm. In at least certain selected embodiments, the coating layer is less than 4 μm, less than 2 μm, or less than 1 μm.

The coating method is not so limited, and the coating layer described herein can be coated onto a porous substrate by at least one of the following coating methods: extrusion coating, roll coating, gravure coating, printing, knife coating, air-knife coating, spray coating, dip coating, or curtain coating. The coating process can be conducted at room temperature or at elevated temperatures.

The coating layer can be any one of nonporous, nanoporous, microporous, mesoporous or macroporous. The coating layer can have a JIS Gurley of 700 or less, sometimes 600 or less, 500 or less, 400 or less, 300 or less, 200 or less, or 100 or less.

One or more layers, treatments, materials, or coatings (CT) and/or nets, meshes, mats, wovens, or non-wovens (NW) can be added on one or both sides, or within the multilayer film or membrane (M) described herein, which can include but not limited to CT/M, CT/M/CT, NW/M, NW/M/NW, CT/M/NW, CT/NW/M/NW/CT, CT/M/NW/CT, etc.

### II. Battery Separator

In some embodiments, a battery separator herein comprises, consists of, or consists essentially of a (i.e., one or more) multilayer membranes or multilayer microporous membranes, and optionally a coating layer on one or both sides of the membrane. The membrane itself, i.e., without a coating or any other additional components, exhibits the improved properties described above. The performance of the membranes can be further enhanced by the addition of coatings or other additional components, such as nonwovens, net, mesh, or the like on one or both sides, with or without a coating, and/or by the described MD, MD-TD or MD-TD-C stretching and calendering.

### III. Composite Vehicle or Device

In an aspect, a composite comprises a multilayer membrane or battery separator as described in Sections I and II, and one or more electrodes, e.g., an anode, a cathode, or an anode and a cathode, provided in direct contact therewith. The type of electrodes are not so limited. For example, the electrodes can be those suitable for use in a lithium ion secondary battery.

A suitable anode can have an energy capacity greater than or equal to 372 mAh/g, preferably ≥700 mAh/g, and most preferably ≥1000 mAH/g. The anode be constructed from a lithium metal foil or a lithium alloy foil (e.g. lithium aluminum alloys), or a mixture of a lithium metal and/or lithium alloy and materials such as carbon (e.g. coke, graphite), nickel, copper. The anode is not made solely from intercalation compounds containing lithium or insertion compounds containing lithium.

A suitable cathode can be any cathode compatible with the anode and can include an intercalation compound, an insertion compound, or an electrochemically active polymer. Suitable intercalation materials includes, for example, MoS₂, FeS₂, MnO₂, TiS₂, NbSe₃, LiCoO₂, LiNiO₂, LiMn₂O₄, V₆O₁₃, V₂O₅, and CuCl₂. Suitable polymers include, for example, polyacetylene, polypyrrole, polyaniline, and polythiopene.

Any separator described hereinabove can be incorporated to any vehicle or device, e.g., an e-vehicle, or device, e.g., a cell phone or laptop, that is completely or partially battery powered.

### IV. Textile

In some embodiments, a textile comprising, consisting of, or consisting essentially of the multilayer microporous membrane or film described herein is described. In some preferred embodiments, the textile comprises the multilayer microporous membrane or film described herein and a non-woven or woven material. The non-woven can be a staple non-woven, a melt-blown non-woven, a spunlaid non-woven, a flashspun non-woven, an air-laid non-woven, or a non-woven made by any other process. In some preferred embodiments, the non-woven or woven is attached to the multilayer microporous membrane or film. In some embodiments, a textile comprises, consists of, or consists essentially of a woven or non-woven, multilayer microporous membrane or film as described herein, and another woven or non-woven in that order. In some embodiments, the textile comprises, consists of, or consists essentially a multilayer microporous membrane or film as described herein, a non-woven or woven, and multilayer microporous membrane or film as described herein, in that order.

### V. Method of Making Multilayer Membranes

In some embodiments, the physical properties of the multilayer membranes described herein are a result of, at least in part, the method by which multilayer membranes are made.

In an aspect, a method comprises at least coextruding two or more polymer mixtures to form a first coextruded bi-layer, tri-layer, or multi-layer membrane, coextruding two or more other polymer mixtures to form a second coextruded bi-layer, tri-layer, or multi-layer membrane, and coextruding two or more further polymer mixtures to form a third coextruded bi-layer, tri-layer, or multi-layer membrane. The polymer mixtures used to form each layer of the first, second, and third bi-layer, tri-layer, or multi-layer layer membrane can be the same or different. The mixtures can only include one polymer, or more than one polymer, such as polymer blends. Also, more than three bi-layer, tri-layer, or multi-layer membranes can be formed. After the first, second, and third bi-layer, tri-layer, or multi-layer membrane is formed, the membranes are laminated together with two of the membranes formed on opposite surfaces of one of the membranes to form the microporous battery separators described herein. The laminated multilayer membrane can be uniaxially or biaxially stretched, and in some instances calendered.

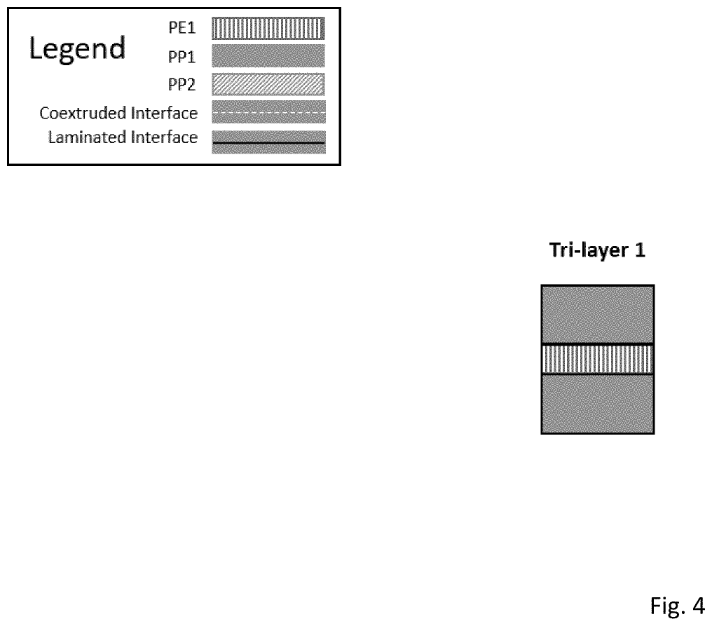

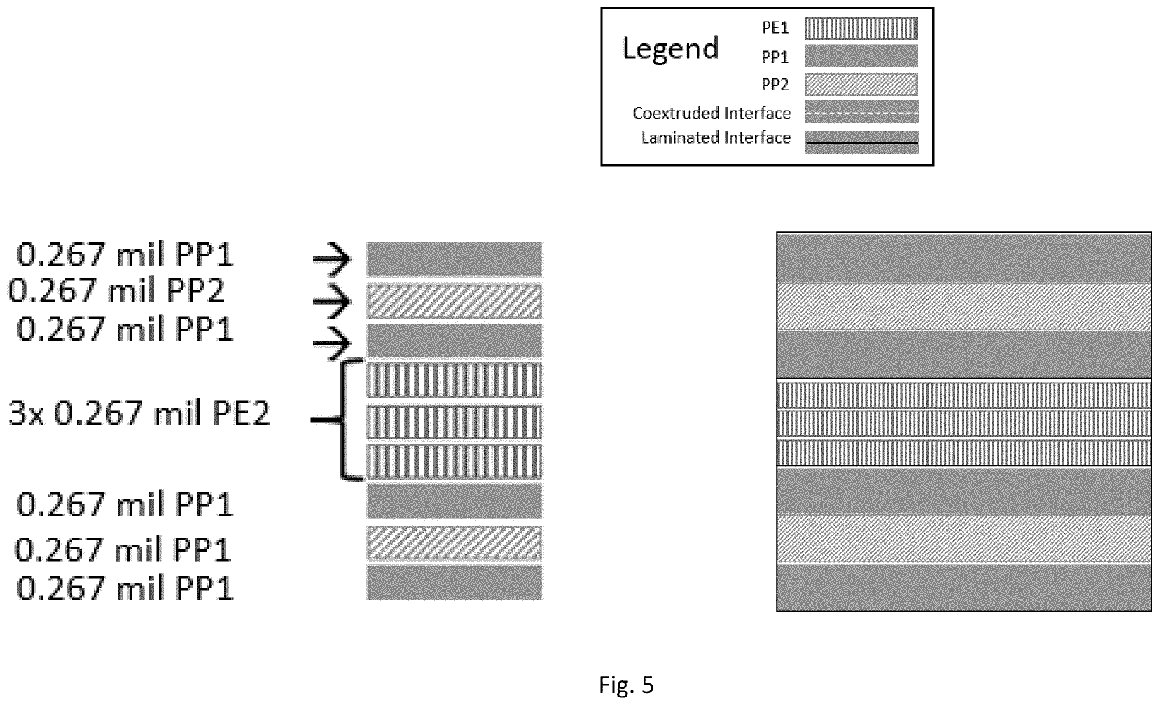

Each layer of the multi-layer membrane can comprise one or more sublayers, microlayers, or plies formed by extrusion or co-extrusion. Co-extrusion typically involves use of a co-extrusion die with one or more extruders feeding the die (typically one extruder per layer of the bi-layer, tri-layer, or multi-layer membrane). An exemplary co-extrusion process is shown in FIG. 4 and a co-extrusion die is shown in FIG. 5.

In some embodiments, the co-extrusion step is performed using a co-extrusion die with one or more extruders feeding the die. Typically, there is one extruder for each desired layer or microlayer of the ultimately formed co-extruded film. For example, if the desired co-extruded film has three microlayers, three extruders are used with the co-extrusion die. In at least one embodiment the multilayer membrane can be constructed of many sublayers, microlayers, or nanolayers wherein the final product can contain 2, 3, 4, 5, 6, 7, 8, 9, 10, or more layers of individual sublayers, microlayers or nanolayers that together comprise a layer in the multilayer membrane. In at least certain embodiments the sublayer technology can be created by a pre-encapsulation feedblock prior to entering a cast film or blown film die.

In some embodiments, the co-extrusion is an air bubble co-extrusion method and the blow-up ration can be varied between 0.5 to 2.0, 0.7 to 1.8, or 0.9 to 1.5. Following co-extrusion using this blow-up ratio, the film can be MD stretched, MD stretched and then TD stretched (with or without MD relax) or simultaneously MD and TD stretched, as described in more detail below. The film can then be optionally calendered to further control porosity.

Co-extrusion benefits include but are not limited to increasing the number of layers (interfaces), which without wanting to be bound by any particular theory, is believed to improve puncture strength. Also, co-extrusion, without wishing to be bound by any particular theory, is believed to result in the observed DB improvement. Specifically, DB improvement can be related to the reduced PP pore size observed when a co-extrusion process is used. Also, co-extrusion allows for a wider number of choices of materials by incorporating blends in the microlayers. Co-extrusion also allows formation of thin tri-layer or multi-layer films (coextruded films). For example, a tri-layer co-extruded film having a thickness of 8 or 10 microns or thinner can be formed. Co-extrusion allows for higher MD elongation, different pore structure (smaller PP, larger PE). Co-extrusion can be combined with lamination to create desired inventive multi-layer structures. For, example, structures as formed in the Examples.

The laminating step comprises bringing a surface of the co-extruded film together with a surface of the at least one other film and fixing the two surfaces together using heat, pressure, and or heat and pressure. Heat can be used, for example, to increase the tack of a surface of either or both of the co-extruded film and the at least one other film to make lamination easier, making the two surfaces stick or adhere together better. The number of lamination steps are not so limited. For example, all of the layers of the membrane may be laminated together or two layers may be laminated together at a time. For example, two layers may be laminated to form a laminate and then another layer may be laminated to that laminate to form a second laminate, and then another layer may be laminated to that second laminate to form a third laminate, etc.

In some embodiments, the laminate formed by laminating the co-extruded film to at least one other film is a precursor for subsequent MD and/or TD stretching steps, with or without relax. In some embodiments, the co-extruded films are stretched before lamination.

Additional steps can comprise, consist of, or consist essentially of an MD, TD, or sequential or simultaneous MD and TD stretching steps. The stretching steps can occur before or after the lamination step. Stretching can be performed with or without MD and/or TD relax. Co-pending, commonly owned, U.S. Published Patent Application Publication No. US2017/0084898 A1 published Mar. 23, 2017 is hereby fully incorporated by reference herein.

Other additional steps can include calendering. For example, in some embodiments the calendering step can be performed as a means to reduce the thickness, as a means to reduce the pore size and/or porosity, and/or to further improve the transverse direction (TD) tensile strength and/or puncture strength of the porous biaxially stretched membrane precursor. Calendering can also improve strength, wettability, and/or uniformity and reduce surface layer defects that have become incorporated during the manufacturing process e.g., during the MD and TD stretching processes. The calendered film or membrane can have improved coat ability (using a smooth calender roll or rolls). Additionally, using a texturized calendering roll can aid in improved coating adhesion to the film or membrane.

Calendering can be cold (below room temperature), ambient (room temperature), or hot (e.g., 90° C.) and can include the application of pressure or the application of heat and pressure to reduce the thickness of a membrane or film in a controlled manner. Calendering can be in one or more steps, for example, low pressure calendering followed by higher pressure calendering, cold calendering followed by hot calendering, and/or the like. In addition, the calendering process can use at least one of heat, pressure and speed to densify a heat sensitive material. In addition, the calendering process can use uniform or non-uniform heat, pressure, and/or speed to selectively densify a heat sensitive material, to provide a uniform or non-uniform calender condition (such as by use of a smooth roll, rough roll, patterned roll, micro-pattern roll, nano-pattern roll, speed change, temperature change, pressure change, humidity change, double roll step, multiple roll step, or combinations thereof), to produce improved, desired or unique structures, characteristics, and/or performance, to produce or control the resultant structures, characteristics, and/or performance, and/or the like.

Another exemplary method of making a multilayer microporous membrane comprises the steps of coextruding a nonporous polypropylene precursor comprising a plurality of sublayers; coextruding a nonporous polyethylene precursor comprising a plurality of sublayers; laminating a plurality of the coextruded polypropylene precursor layers with the extruded polyethylene precursor layers to form a first intermediate precursor having alternating polyethylene and polypropylene layers; simultaneously laminating a first outer layer comprising the coextruded polypropylene precursor to a first surface of the intermediate precursor and a second outer layer comprising the coextruded polypropylene precursor to a second surface of the first intermediate precursor opposite the first surface to form a second intermediate precursor; annealing the second intermediate precursor to form an annealed multilayer membrane; stretching the annealed multilayer membrane to form a microporous multilayer membrane, wherein the stretching is uniaxial or biaxial; and optionally calendering the microporous multilayer membrane. In some preferred embodiments, calendering is performed. This method is non-limiting. For example, the first intermediate precursor may comprise all polyethylene or all polypropylene precursors.

In some instances, the first intermediate precursor comprises a trilayer membrane having a structure of PE/PP/PE or (PP/PP/PP)/(PE/PE/PE)/(PP/PP/PP), and the second intermediate precursor comprises a penta-layer membrane having a structure of PP/PE/PP/PE/PP or (PP/PP/PP)/(PE/PE/PE)/(PP/PP/PP)/(PE/PE/PE)/(PP/PP/PP).

Each of the coextruded polypropylene precursor layers can comprise a single monolayer or two, three, four, or more sublayers, and each of the extruded polyethylene precursor can comprise a single monolayer or two, three, four, or more sublayers. In one embodiment, the second intermediate precursor comprises a penta-layer membrane having a structure of PP/PE/PP/PE/PP, where each layer comprises three sublayers. For example, the structure is (PP/PP/PP)/(PE/PE/PE)/(PP/PP/PP)/(PE/PE/PE)/(PP/PP/PP).

The coextruded polypropylene precursor and the polyethylene precursor are nonporous, and can be made to be microporous through the stretching steps. The uniaxial stretching can be in the machine direction or the transverse direction, and the biaxial stretching can be in the machine direction and transverse direction. The biaxial machine direction and transverse direction stretching can be sequential or simultaneous.

In some embodiments, there is a calendering step. Calendering may comprise application of heat, pressure, or heat and pressure.

In some embodiments, the method further comprising the step of coating one or more of the first outer layer and the second outer layer, such as in example where the membrane is a battery separator.

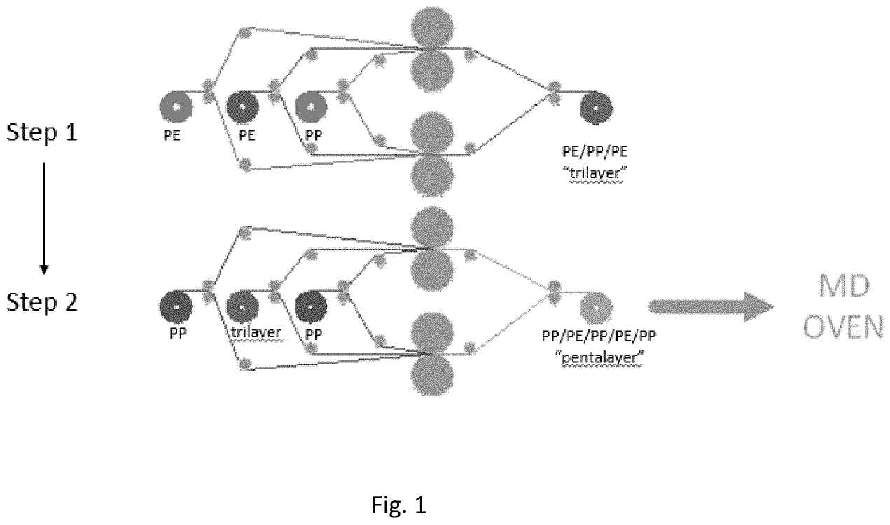

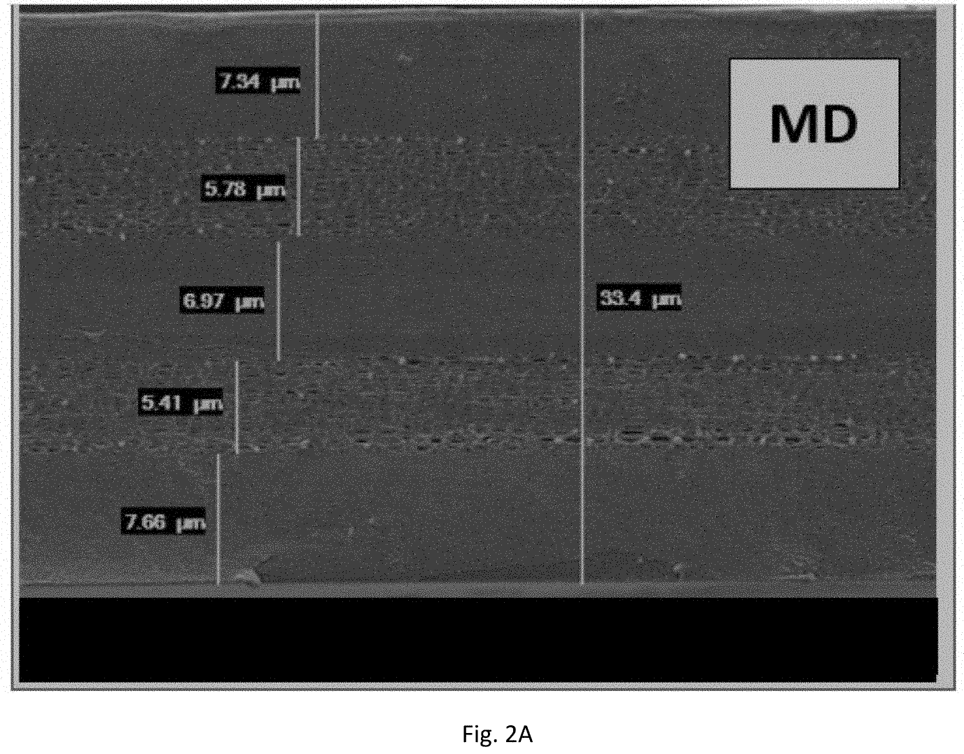

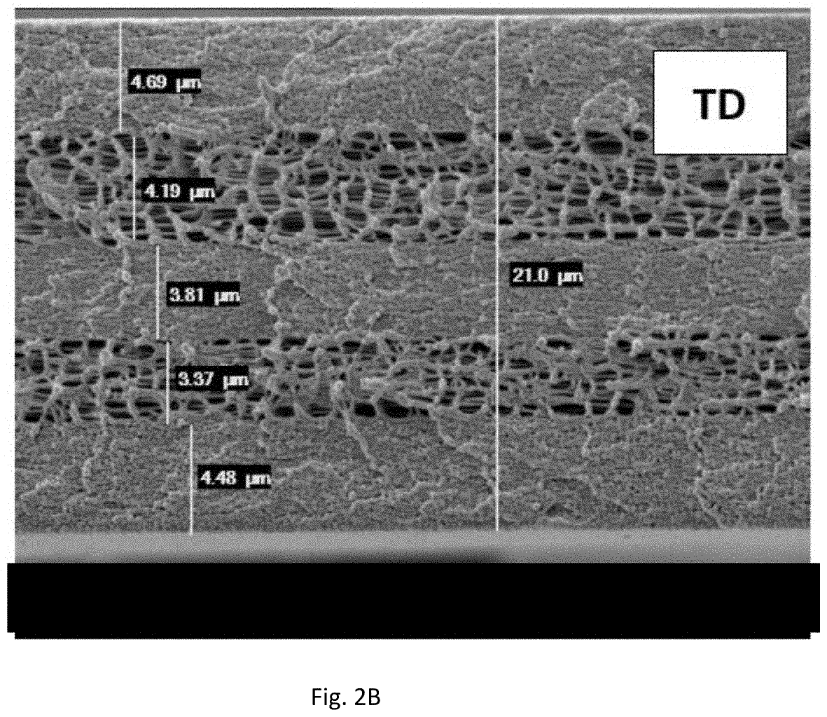

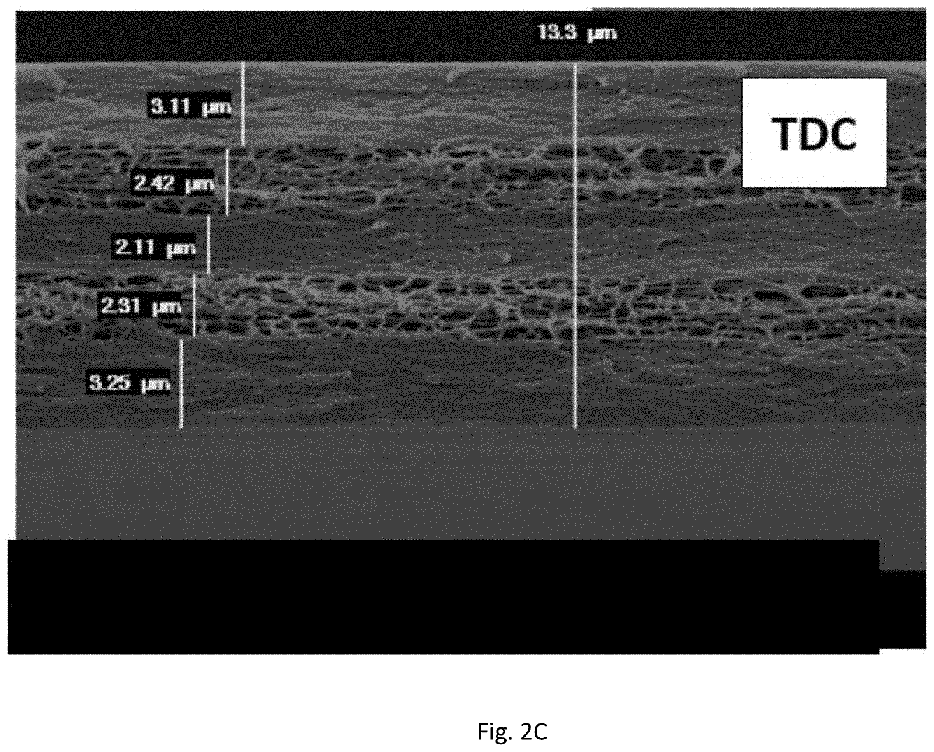

In another embodiment of a method for making a pentalayer membrane with a general structure of PP/PE/PP/PE/PP or (PP/PP/PP)/(PE/PE/PE)/(PP/PP/PP)/(PE/PE/PE)/(PP/PP/PP) and in some embodiments a specific structure of (PP1,PP2,PP3)/(PE1,PE2,PE3)/(PP1,PP2,PP3)/(PE1,PE2,PE3)/(PP1,PP2,PP3), where each layer comprises three sublayers or plies, the method comprises a Step 1 and a Step 2, as shown in FIG. 1.

FIG. 1 shows an exemplary method of making a pentalayered membrane having a general structure of PP/PE/PP/PE/PP or (PP/PP/PP)/(PE/PE/PE)/(PP/PP/PP)/(PE/PE/PE)/(PP/PP/PP). The trilayer component may have a structure PE/PP/PE or (PE/PE/PE)/(PP/PP/PP)/(PE/PE/PE). This is a two step process, but the pentalayer may be formed in one step where all five layers are laminated together. A method using more than two steps is also possible.

In Step 1, an inverted trilayer membrane is created by laminating a first layer of polyethylene to a first side of a middle polypropylene layer, and laminating a second layer of a polyethylene to a second side of the middle polypropylene layer to give a trilayer having a structure of PE/PP/PE. A non-inverted trilayer PP/PE/PP may also be formed. The first and second polyethylene layers and the middle polypropylene layer of the trilayer can each be a single monolayer, or have multiple sublayers, as described above in Section I. In preferred embodiments, each layer may comprise sublayers. In Step 2, the trilayer is used as a middle layer, and a first outer polypropylene layer (or polyethylene) is laminated to the first layer of polyethylene or one side of the trilayer, and a second outer polypropylene layer (or polyethylene) is laminated to the second layer of polyethylene or an opposite side of the trilayer to give a pentalayer membrane having a structure of PP/PE/PP/PE/PP. Again, the first and second outer layers of polypropylene (or polyethylene) can each be a single monolayer, or have multiple sublayers, as described above in Section I. If the first and second outer layers have multiple sublayers (2 or more), the thickness of the outermost and exposed sublayer may be thicker than or thinner than or the same thickness as the inner sublayers. In one embodiment, each of the layers in the pentalayer membrane comprise 3 sublayers, for a total of 15 sublayers. Structure is (PP/PP/PP)/(PE/PE/PE)/(PP/PP/PP)/(PE/PE/PE)/(PP/PP/PP).

In yet another exemplary method of making a pentalayered microporous membrane, the method comprises the steps of extruding a plurality of polypropylene membranes and polyethylene membranes; laminating one of the polyethylene membranes to a first side of a polypropylene membrane and another one of the polyethylene membranes to an opposite second side of the polypropylene membrane to form an inverted trilayer membrane having a structure of PE/PP/PE or (PE/PE/PE)/(PP/PP/PP)/(PE/PE/PE); laminating one of the polypropylene layers to one of the polyethylene membranes in the trilayer membrane and another of the polypropylene layers to the other polyethylene membrane in the trilayer membrane to form a penta-layer membrane having a structure of PP/PE/PP/PE/PP or (PP/PP/PP)/(PE/PE/PE)/(PP/PP/PP)/(PE/PE/PE)/(PP/PP/PP); stretching the annealed multilayer membrane to form a microporous multilayer membrane, wherein the stretching is uniaxial or biaxial; and optionally calendering the microporous multilayer membrane. In some embodiments, the trilayer can be PP/PE/PP or (PP/PP/PP)/(PE/PE/PE)/(PP/PP/PP) and the pentalayer structure may be (PE/PE/PE)/(PP/PP/PP)/(PE/PE/PE)/(PP/PP/PP)/(PE/PE/PE). The trilayer may also be all PP or all PE, e.g., PP/PP/PP or PE/PE/PE or (PP/PP/PP)/(PP/PP/PP)/(PP/PP/PP) or (PE/PE/PE)/(PE/PE/PE)/(PE/PE/PE). The pentalayer may be PE/PP/PP/PP/PE or PP/PE/PE/PE/PP or (PE/PE/PE)/(PP/PP/PP)/(PP/PP/PP)/(PP/PP/PP)/(PE/PE/PE) or (PP/PP/PP)/(PE/PE/PE)/(PE/PE/PE)/(PE/PE/PE)/(PP/PP/PP).

### Example 1

### Composition of Experimental Penta-Layer

The composition of the Experimental penta-layer membrane is (PP1/PP1/PP1)/(PE1/PE1/PE1)/(PP1/PP1/PP1)/(PE1/PE1/PE1)/(PP1/PP1/PP1), where PP1 is homopolymer PP, density range of 0.90-0.92 g/cm³, MFR in the range of 0.5MFR-2MFR. A11 PE1 layers are high density polyethylene with melt index between 0.25-0.5 g/10 min at 2.16 kg and 190 deg C, and density range between 0.95-0.97 g/cm³.

### Method of Making the Penta-Layer: (PP/PP/PP)/(PE/PE/PE)/(PP/PP/PP)/(PE/PE/PE)/(PP/PP/PP)

The penta-layer membrane of EXAMPLE 9 having a structure of (PP1/PP1/PP2)/(PE2/PE2/PE2)/(PP1/PP2/PP1)/(PE2/PE2/PE2)/(PP2/PP1/PP1) was manufactured by coextruding layers having a structure (PP1/PP1/PP2), layers having a structure (PE2/PE2/PE2), layers having a structure (PP1/PP2/PP1) and layers having a structure (PP2/PP1/PP1). These co-extruded layers were then laminated together to form an intermediate having a structure of (PP1/PP1/PP2)/(PE2/PE2/PE2)/(PP1/PP2/PP1)/(PE2/PE2/PE2)/(PP2/PP1/PP1) and the intermediate was stretched in the MD and TD directions and then calendered.

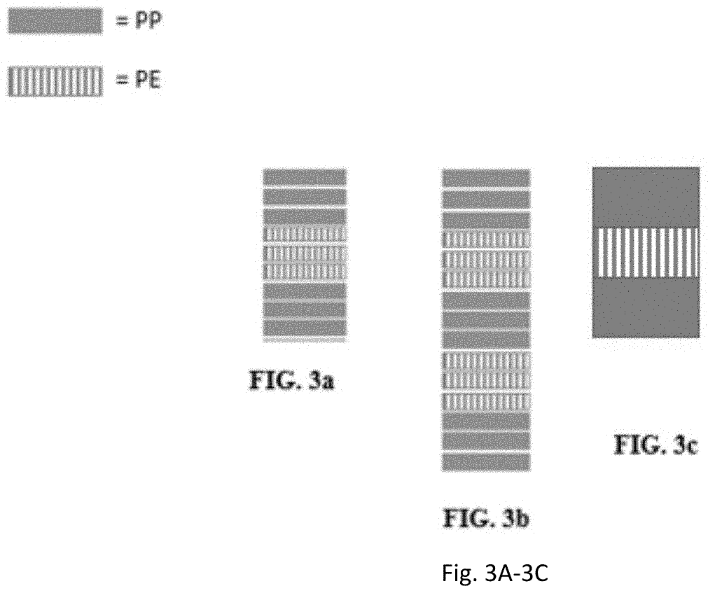

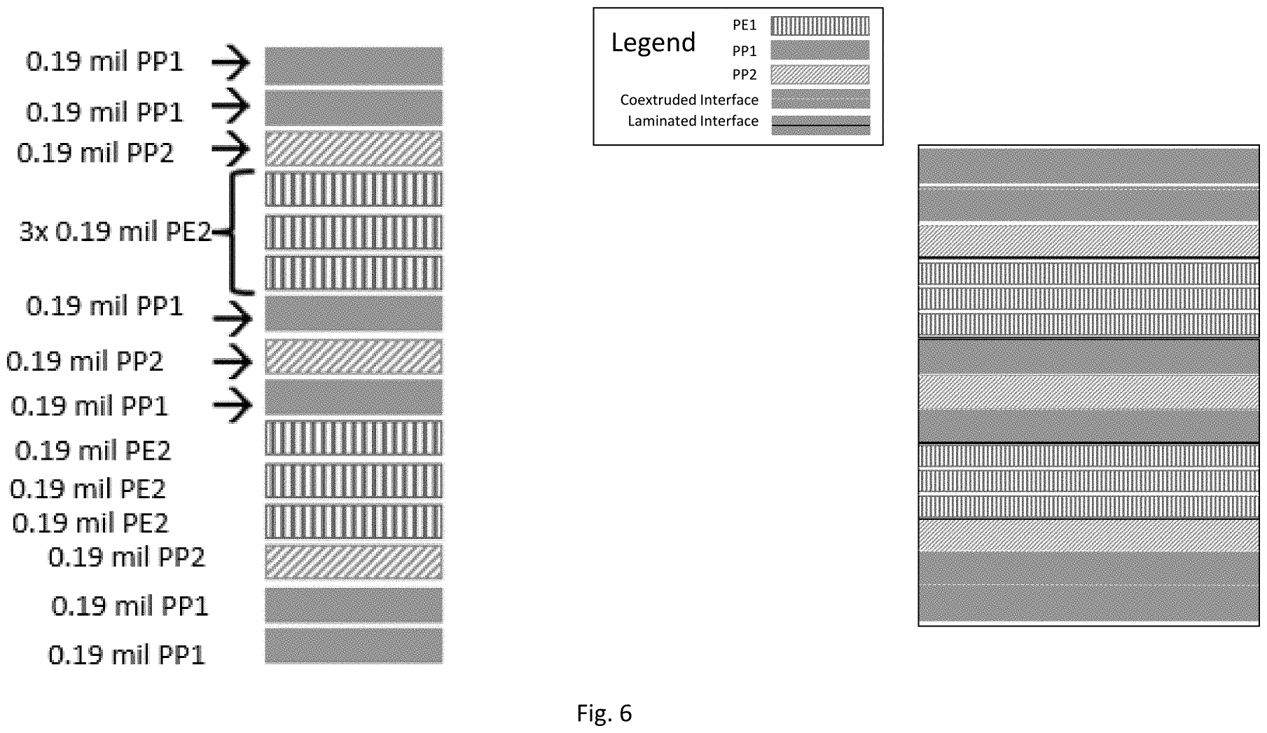

The penta-layer is shown schematically in FIGS. 6 and 3b. The PP1:PP2:PP1 ratio is 1:1:1. The PP1:PP1:PP2 ratio is 1:1:1. The PP:PE:PP:PE:PP ratio is 15:10:15:10:15. Total PE amount is 30%.

### SEM Images of MD, TD, and TDC

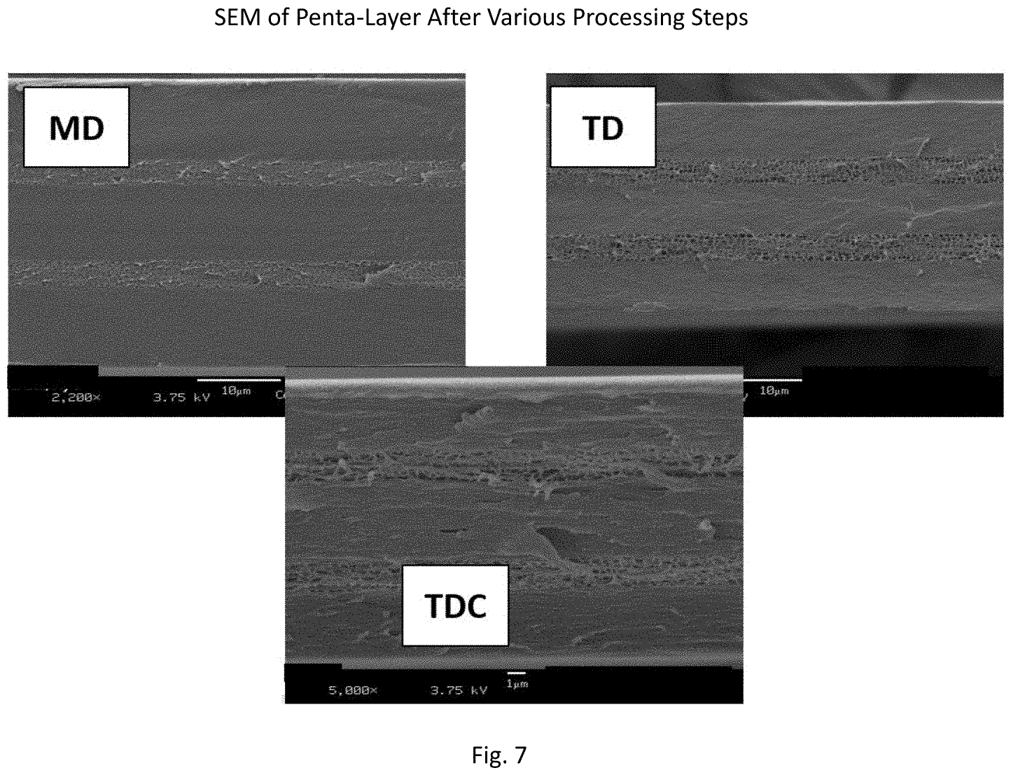

FIG. 7 show a scanning electron microscope (SEM) image of a penta-layered membrane having a general structure of PP/PE/PP/PE/PP, where each layer (e.g., PP of the structure PP/PE/PP/PE/PP is considered a layer) has three sublayers (for a combined total of 15 sublayers). See, for example, FIG. 3b and FIG. 6. The SEM micrograph in FIG. 7 marked “MD” is of the penta-layered membrane after being stretched uniaxially in the MD. The pores have a rectangular slit-shape. The SEM micrograph in FIG. 7 marked “TD” is of the penta-layered membrane after a sequential MD-TD stretching. As shown in the SEM micrograph in FIG. 7 marked “TD”, there is a more open porous structure of the inner PE microporous layers sandwiched by PP microporous layers, and the pores have an approximate round-shape appearance. The SEM micrograph marked “TDC” in FIG. 7 is of the penta-layered membrane after a combined TD stretching and subsequent calendering (TDC) of the MD-stretched membrane in the SEM micrograph of FIG. 7 marked “MD.” The calendering process involves heat and pressure and can reduce the thickness of the membrane in a controlled fashion.

### EXAMPLE 2 (Tri-Layer 1)

### Composition of the First Tri-layer (tri-layer 1): PP1/PE1/PP1

All PP1 layers are made of a homopolymer PP density range of 0.90-0.92 g/cm\hat{ }3, MFR in the range of 0.5MFR-2MFR. All PE1 layers are high density polyethylene with melt index between 0.25-0.5 g/10 min at 2.16 kg and 190 deg C, and density range between 0.95-0.97 g/cm³.

### Method of Making Tri-Layer 1: PP1/PE1/PP1

The first trilayer of Example 5 was formed by extruding two PP monolayers and a PE monolayer. Next, the monolayers were laminated so that the two PP monolayers were laminated on either side of the PE monolayer to form an intermediate, which was then stretched in the MD and TD and then calendered. The monolayers may be laminated all together or one PP monolayer may be laminated to the PE monolayer and then the other PP monolayer may be laminated. The PP:PE:PP ratio is 2:1:2, with the total amount of PE being 20%.

The first trilayer is shown schematically in FIG. 4 and FIG. 3c.

### Example 3 (Tri-Layer 2)

### Composition of the Tri-Layer 2

The composition of the second tri-layer is (PP1/PP2/PP1)/(PE2/PE2/PE2)/(PP1/PP2/PP1) PP1 is homopolymer PP, density range of 0.90-0.92 g/cm³, MFR in the range of 0.5MFR—2MFR. PP2 is blend made of 90% of the homopolymer PP in PP1 and 10% of a propylene-ethylene elastomer. PE1 is made of a blend of 95% high density polyethylene with a melt index between 0.25-0.5 g/10 min at 2.16 Kg and 190 degrees centigrade and a density range between 0.95-0.97 g/cm³ and 5% mLLDPE.

### Method of Making the Tri-Layer 2

Tri-layer 2 was formed by co-extruding PP-containing layers having the composition described in Example 7 above (i.e., PP1/PP2/PP1) and PE-containing layers having the composition described in Example 7 above (i.e., PE2/PE2/PE2), each of the PP-containing layers and the PE-containing layers having three sub-layers as shown in FIG. 3a. Then, two PP-containing layers were laminated on either side of a PE-containing layer to form an intermediate. This intermediate was then MD and TD stretched and then calendered.

Tri-layer 2 is shown schematically in FIGS. 5 and 3a. The PP1:PP2:PP1 ratio is 1:1:1. The PP:PE:PP ratio is 2:1:2. Total PE is 20%.

### Example 4 (Second Pentalayer)

### Composition of Second Pentalayer

Second pentalayer has a structure PP1/PE1/PP1/PE1/PP1, where PP1 and PE1 are as described herein.

### Method of Making Second Pentalayer

Second pentalayer is formed by extruding monolayers made of PP1 and PE1 respectively, and then laminating those monolayers to form a structure PP1/PE1/PP1/PE1/PP1. This laminate was the MD and TD stretched and then calendered.

### Example 5 (Collapsed Bubble Co-Extrusion)

### Composition

The composition of Example 5 has a structure PP1/PP2/PE1/PE1/PP2/PP1, where PP1, PP2, and PE1 are as described herein.

### Method of Making

Example 5 was formed by co-extruding a trilayer PP1/PP2/PE1 using a bubble extrusion method and collapsing the bubble which results in lamination of the PE1 layers on either side of the bubble to one another. This laminate was then the MD and TD stretched and then calendered. This embodiment has one lamination interface and it is a PE/PE lamination interfaces.

### Example 6 (Multilaminate)

### Composition of Example 5

Example 6 has a structure PP1/PP2/PE1/PE1/PP2/PP1 where PP1, PP2, and PE1 are as described herein.

### Method of Making Example 6

Six monolayers were co-extruded (2 PP1 monolayers, 2PP2 monolayers, and 2 PE1 monolayers), and they were laminated together to form the structure of Example 6, which has 5 lamination interfaces (only 2 PP/PE lamination interfaces). This laminate was then the MD and TD stretched and then calendered.

### Example 7 (Multilaminate)

### Composition

Example 7 has a structure PP1/PE1/PP2/PP2/PE1/PP1 where PP, PP2, and PE 1 are as described herein.

### Method of Making Example 7

Six monolayers (2 PP1 monolayers, 2 PE1 monolayers, and 2 PP2 monolayers) were extruded and laminated together to form the structure above. This laminate was then the MD and TD stretched and then calendered. This laminate has 5 lamination interfaces. It has 4 PP/PE lamination interfaces.

### Results

### Comparison of MD-stretched Penta-layered Membrane of Example 1

Table 1 below shows the comparative properties of a uniaxial MD-stretched penta-layered membrane 1 (Example 1) having a composition and structure (PP/PP/PP)/(PE/PE/PE)/(PP/PP/PP)/(PE/PE/PE)/(PP/PP/PP) shown in FIG. 3b in comparison with an MD-stretched first tri-layer membrane (Example 2) having the composition and structure (PP/PE/PP) shown in FIG. 3c and second tri-layer membrane (Example 3) having a composition and structure (PP/PE/PP) shown in FIG. 3a. As shown below, each of the layers in FIG. 3b comprise three sublayers each, and the layers of the second tri-layer in FIG. 3a also comprises sublayers. Notably, FIGS. 3a-3c are not drawn to scale, but, rather, are drawn to show the where the first and second trilayers correspond to portions of the penta-layered membrane. As shown in Tables 1-3, the overall thickness of the first and second trilayers is approximately equal (with some variations disclosed in the Table 1-3) to the overall thickness of the penta-layer membrane. Thus, each sublayer in the penta-layer membrane has a smaller average thickness than the average thickness of the corresponding sublayer in the first and second trilayers. The PP material and PE material used in the pentalayered membrane and the second trilayer membrane are identical.

TABLE 1
Comparative properties of an MD-stretched Penta-layered
Membrane of Example 1 compared to MD stretched First
and Second Tri-layer of Comparative Examples 1 and 2.

| | | First | Second | Penta- |
|---|---|---|---|---|
| Property | Units | Tri-layer | Tri-layer | layer |
| Thickness | Microns | 42 | 39 | 37 |
| Gurley | S | 2,400 | 7,500 | 2,300 |
| Relative Gurley | | 1.0 | 3.1 | 1.0 |
| Puncture | g | 850 | 780 | 1000 |
| MD shrinkage @ | % | 4.9 | 9.5 | 12.0 |
| 120° C. | | | | |
| for 1 hr | | | | |
| MD tensile @ | kg/cm² | 2,050 | 1,950 | 2,600 |
| break | | | | |
| TD tensile @ | kg/cm² | 140 | 160 | 155 |
| break | | | | |
| TD elongation @ | % | 620 | 1,020 | 1,080 |
| break | | | | |

### TD-Stretched Comparison of Penta-Layered Membrane of Example 1 with the First and Second Tri-Layers of Examples 2 and 3

Table 2 below shows the comparative properties of a TD stretched penta-layered membrane having a composition and structure (PP/PP/PP)/(PE/PE/PE)/(PP/PP/PP)/(PE/PE/PE)/(PP/PP/PP) shown in FIG. 3b in comparison with an TD-stretched first tri-layer membrane having the composition and structure (PP/PE/PP) shown in FIG. 3c and second tri-layer membrane having a composition and structure (PP/PP/PP)/(PE/PE/PE)/(PP/PP/PP) shown in FIG. 3a.

TABLE 2
Comparative properties of a TD-stretched Penta-layered Membrane

| | | First Tri-layer | | Second tri-layer | | Penta-layer | |
|---|---|---|---|---|---|---|---|
| Property | Units | (Example 2) | | (Example 3) | | (Example 1) | |
| Stretch ratio | % | 450 | 600 | 450 | 600 | 450 | 600 |
| Gurley | s | 101 | 60 | 80 | — | 85 | 80 |
| Thickness | microns | 28 | 23 | 20 | — | 20 | 16 |
| Puncture | g | 290 | 220 | 280 | — | 310 | 255 |
| MD shrinkage @ | % | 21.2 | 41.0 | 23.0 | — | 16.7 | 23.4 |
| 120° C. for 1 hr | | | | | | | |
| TD shrinkage@ | % | 4.0 | 9.0 | 9.3 | — | 12.5 | 14.4 |
| 120° C. for 1 hr | | | | | | | |
| MD Tensile @ break | kg/cm² | 880 | 605 | 916 | — | 1,160 | 1,185 |
| MD elongation@ break | % | 112 | 78 | 145 | — | 93 | 92 |
| MD Modulus | kg/cm² | | | | | 2,598 | 2,604 |
| TD tensile @ break | kg/cm² | 380 | 420 | 494 | — | 355 | 455 |
| TD elongation @ break | % | 158 | 89 | 115 | — | 97 | 76 |
| TD modulus | kg/cm² | | | | | 1,743 | 1,995 |
| Calculated porosity | % | 68 | 75 | 67 | — | 64 | 65 |
| Dielectric Breakdown | V | 1,620 | | | — | — | 1,750 |

### Comparison of TDC Penta-Layered Membrane of Example 1 with the First and Second Tri-Layers of Examples 2 and 3

Table 3 below shows the comparative properties of a TD-stretched and calendered penta-layered membrane having a composition and structure (PP/PP/PP)/(PE/PE/PE)/(PP/PP//PP)/(PE/PE/PE)/(PP/PP/PP) shown in FIG. 3b in comparison with TD stretched and calendered tri-layer membrane having the composition and structure (PP/PE/PP) shown in FIG. 3c and second tri-layer membrane having a composition and structure (PP/PP/PP)/(PE/PE/PE)/(PP/PP/PP) shown in FIG. 3a.

TABLE 3
Comparative properties of a TD-stretched
and calendered Penta-layered Membrane

| | | First | Second | Penta- |
|---|---|---|---|---|
| | | tri-layer | Tri-layer | layer |
| Property | Units | (Example 2) | (Example 3) | (Example 1) |
| Gurley | s | 130 | 200 | 200 |
| Thickness | Microns | 14 | 14 | 14 |
| Puncture | g | 340 | 360 | 380 |
| MD shrinkage@ | % | 26.0 | 15.2 | 15.3 |
| 120° C. | | | | |
| for 1 hour | | | | |
| TD shrinkage @ | % | 10.0 | 5.9 | 14.1 |
| 120° C. | | | | |
| for 1 hour | | | | |
| MD tensile @ | kg/cm² | 1,300 | 1,350 | 1,780 |
| break | | | | |
| TD tensile @ | kg/cm² | 775 | 625 | 510 |
| break | | | | |
| Dielectric | V | 1,657 | 1,916 | — |
| Breakdown | | | | |
| DB standard | V | 79 | 57 | |
| deviation | | | | |
| DB minimum | V | 1,460 | 1,800 | |
| Porosity, | % | 52 | 44 | |
| intrusion | | | | |
| Porosity, | % | | | 41 |
| Calculated | | | | |

As can be seen by the comparison of the penta-layered embodiment (Example 1) with the two tri-layer embodiments (Example 2 and Example 3), the penta-layered embodiment exhibits, for example, improved puncture. This is believed to be due at least in part to the lamination interfaces compared to the first trilayer, which has none and/or the increased number of lamination interfaced compared to the second-trilayer, which has two lamination interfaces. It is hypothesized that three or more lamination interfaces improves properties of the microporous membrane. It has been shown that four lamination interfaces improve the property of the microporous film.

Table 4 compares properties of MD-stretched Trilayer 1 (Example 2) and second pentalayer (Example 4)

| | | | Second |
|---|---|---|---|
| | | Trilayer 1 | Pentalayer |
| Property | Units | (Example 2) | (Example 4) |
| Relative JIS | — | 1.0 | 1.0 |
| Gurley | | | |
| Puncture | g/micron | 17.2 | 21.4 |
| MD Tensile @ | Kg/cm² | 1,700 | 2,150 |
| Break | | | |
| TD Elongation @ | % | 950 | 1,020 |
| break | | | |

Table 5 compares properties of MD and TD-stretched Trilayer 1 (Example 2) and second pentalayer (Example 4)

| | | | Second |
|---|---|---|---|
| | | Trilayer 1 | Pentalayer |
| Property | Units | (Example 2) | (Example 4) |
| Relative JIS | — | 1.0 | 0.7 |
| Gurley | | | |
| Puncture | g/micron | 10.0 | 8.8 |
| MD Tensile @ | Kg/cm² | 750 | 1,000 |
| Break | | | |

Table 6 compares properties of MD and TD stretched and then calendered Trilayer 1 (Example 2) and second pentalayer (Example 4)

| | | | Second |
|---|---|---|---|
| | | Trilayer 1 | Pentalayer |
| Property | Units | (Example 2) | (Example 4) |
| Relative JIS | — | 1.0 | 1.0 |
| Gurley | | | |
| Puncture | g/micron | 17.9 | 23.3 |
| MD tensile @ | Kg/cm² | 1,200 | 1,700 |
| break | | | |

Thus, Tables 4-6 show improvement in a product having 4 lamination interfaces (second pentalayer, Example 4) compared to a product having 2 lamination interfaces (trilayer 1, Example 2). In these Examples, each of the lamination interfaces are PP/PE lamination interfaces where the layers or sublayers at the interfaces are PP on one side of the interface and PE on the other.

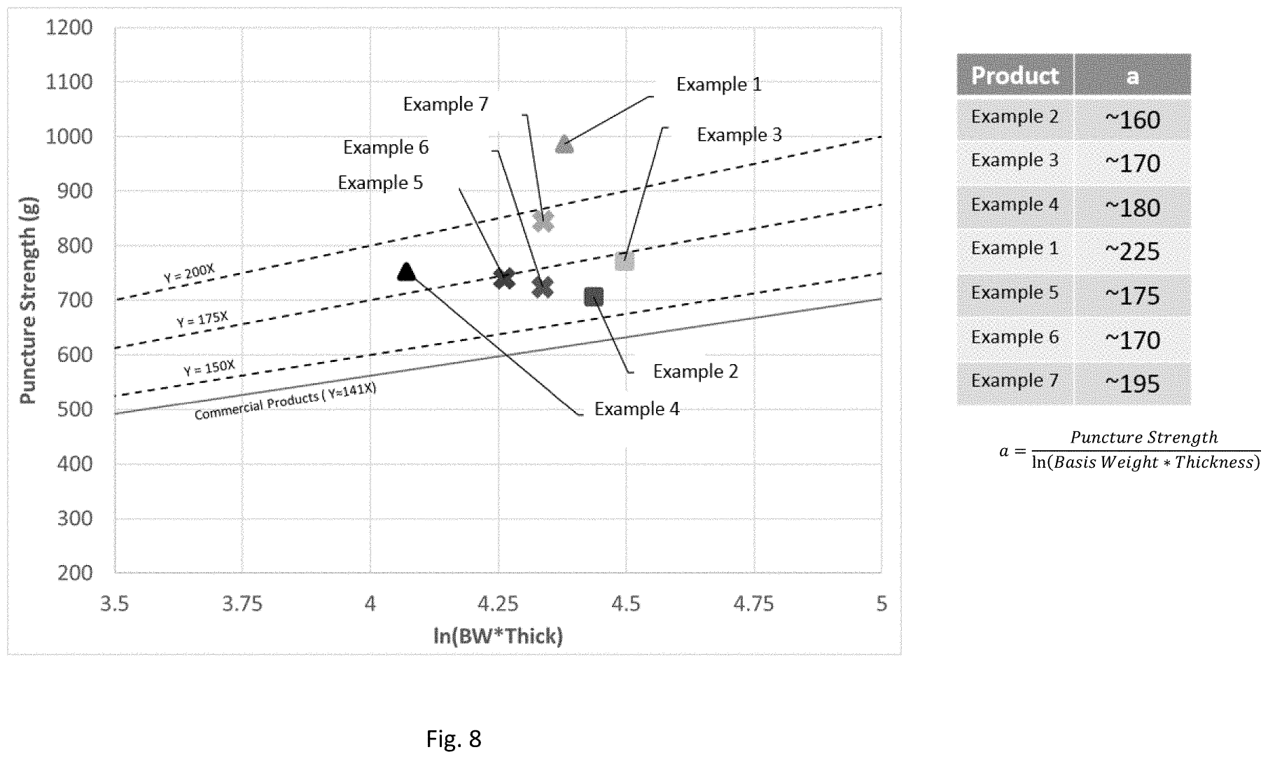

Normalized puncture strength for Examples 1 to 7 is shown in FIG. 8. In FIG. 8, the “a” value is a normalized puncture strength value calculated as shown in the figure. From the results in FIG. 8, some conclusions are that the number of PP/PE interfaces had a strong influence on resulting strength of the Example. Compare Example 2 with 2 PP/PE lamination interfaces to Example 4 with 4 PP/PE lamination interfaces. Compare Example 4 with 4 lamination interfaces to Example 7 with 5 lamination interfaces. Compare Example 2 with Example 6. These have 2 and 5 lamination interfaces, respectively, but the same number of PP/PE lamination interfaces.

In at least another embodiment, the porous membrane could be a base film for coating, dipping or impregnation, for example, a base film for a gradient or controlled impregnation or coating (for example, if a partially pre-wetted membrane was coated with a PO dipping solution). The coating would in this case only partially impregnate the membrane. There could be a controlled impregnation, for example, where the dipping material is a blend of two polymer resins where one more easily penetrates the membrane than the other (which would remain near the surface).

The membrane or separator may be a cut piece, slit, leaf, sleeve, pocket, envelope, wrap, Z fold, serpentine, and/or the like. The membrane or separator may be a flat sheet, tape, slit, non-woven, woven, mesh, knit, hollow fiber, and/or the like. The membrane or separator may be adapted for use in a electrochemical device, battery, cell, ESS, UPS, capacitor, supercapcitor, double layer capacitor, fuel cell (PEM, humidity control membrane,..), catalyst carrier, carrier, pancake (anode, separator, cathode), base film, coated base film, textile, barrier layer in textile, hazmat suit, barrier layer in hazmat suit, blood barrier, water barrier, filtration media, blood, blood components, blood oxygenator, disposable lighter, and/or the like.

The instant battery separator may be a co-extruded, multi-layered battery separator. Co-extruded refers to a process where polymers are simultaneously brought together in an extrusion die and exit from the die in a form, here a generally planar structure, having at least two discrete layers joined together at the interface of the discrete layers by, for example, a commingling of the polymers forming the interface of the discrete layers. The extrusion die may be either a flat sheet (or slot) die or a blown film (or annular) die. The co-extrusion process shall be described in greater detail below. Multi-layered refers to a separator having at least two layers. Multi-layered may also refer to structures with 3, 4, 5, 6, 7, or more layers. Each layer is formed by a separate polymer feed stream into the extrusion die. The layers may be of differing thicknesses. Most often, at least two of the feed streams are of dissimilar polymers. Dissimilar polymer refers to: polymers having dissimilar chemical natures (e.g., PE and PP, or PE and a co-polymer of PE are polymers having dissimilar chemical natures); and/or polymer having the same chemical nature but dissimilar properties (e.g., two PE's having differing properties (e.g., density, molecular weights, molecular weight distributions, rheology, additives (composition and/or percentage), etc.)) However, the polymers may be the same or identical.

The polymers that may be used in the instant battery separator are those that are extrudable. Such polymers are typically referred to as thermoplastic polymers. Exemplary thermoplastic polymers include, but are not limited to: polyolefins, polyacetals (or polyoxymethylenes), polyamides, polyesters, polysulfides, polyvinyl alcohols, polyvinyl esters, and polyvinylidenes. Polyolefins include, but are not limited to: polyethylene (including, for example, LDPE, LLDPE, HDPE, UHDPE), polypropylene, polybutylene, polymethylpentane, co-polymers thereof, and blends thereof. Polyamides (nylons) include, but are not limited to: polyamide 6, polyamide 66, Nylon 10,10, polyphthalamide (PPA), co-polymers thereof, and blends thereof. Polyesters include, but are not limited to: polyester terephalthalate, polybutyl terephalthalate, co-polymers thereof, and blends thereof. Polysulfides include, but are not limited to, polyphenyl sulfide, co-polymers thereof, and blends thereof. Polyvinyl alcohols include, but are not limited to: ethylene-vinyl alcohol, co-polymers thereof, and blends thereof. Polyvinyl esters include, but are not limited to, polyvinyl acetate, ethylene vinyl acetate, co-polymers thereof, and blends thereof. Polyvinylidenes include, but are not limited to: fluorinated polyvinylidenes (e.g., polyvinylidene chloride, polyvinylidene fluoride), co-polymers thereof, and blends thereof.

Various materials may be added to the polymers. These materials are added to modify or enhance the performance or properties of an individual layer or the overall separator.

Materials to lower the melting temperature of the polymer may be added. Typically, the multi-layered separator includes a layer designed to close its pores at a predetermined temperature to block the flow of ions between the electrodes of the battery. This function is commonly referred to as ‘shutdown.’ In one embodiment, a trilayer separator has a middle shutdown layer. To lower the shutdown temperature of the layer, materials, with a melting temperature less than the polymer to which they are mixed, may be added to the polymer. Such materials include, but are not limited to: materials with a melting temperature less than 125.degree. C., for example, polyolefins or polyolefin oligomers. Such materials include, but are not limited to: polyolefin waxes (polyethylene wax, polypropylene wax, polybutene wax, and blends thereof). These materials may be loaded into the polymer at a rate of 5-50 wt % of the polymer. Shutdown temperatures below 140 degree C. are obtainable in one embodiment. Shutdown temperatures below 130 degree C. are obtainable in other embodiments.

Materials to improve the melt integrity of the membrane may be added. Melt integrity refers to the ability of the membrane to limit its loss or deterioration of its physical dimension at elevated temperatures such that the electrodes remain physically separated. Such materials include mineral fillers. Mineral fillers include, but are not limited to: talc, kaolin, synthetic silica, diatomaceous earth, mica, nanoclay, boron nitride, silicon dioxide, titanium dioxide, barium sulfate, calcium carbonate, aluminum hydroxide, magnesium hydroxide and the like, and blends thereof. Such materials may also include, but are not limited to, fine fibers. Fine fibers include glass fibers and chopped polymer fibers. Loading rates range from 1-60 wt % of the polymer of the layer. Such materials may also include high melting point or high viscosity organic materials, e.g., PTFE and UHMWPE. Such materials may also include cross-linking or coupling agents.

Materials to improve the strength or toughness of the membrane may be added. Such materials include elastomers. Elastomers include, but are not limited to: ethylene-propylene (EPR), ethylene-propylene-diene (EPDM), styrene-butadiene (SBR), styrene isoprene (SIR), ethylidene norbornene (ENB), epoxy, and polyurethane and blends thereof. Such materials may also include, but are not limited to, fine fibers. Fine fibers include glass fibers and chopped polymer fibers. Loading rates range from 2-30 wt % of the polymer of the layer. Such materials may also include cross-linking or coupling agents or high viscosity or high melting point materials.

Materials to improve the antistatic properties of the membrane may be added. Such materials include, for example, antistatic agents. Antistatic agents include, but are not limited to, glycerol monostreates, ethoxylated amines, polyethers (e.g., Pelestat 300, commercially available from Sanyo Chemical Industrial of Japan). Loading rates range from 0.001-10 wt % of the polymer of the layer.

Materials to improve the surface wettability of the separator may be added. Such materials include, for example, wetting agents. Wetting agents include, but are not limited to, ethoxylated alcohols, primary polymeric carboxylic acids, glycols (e.g., polypropylene glycol and polyethylene glycols), polyolefin functionalized with maleic anhydride, acrylic acid, glycidyl methacrylate. Loading rates range from 0.01-10 wt % of the polymer of the layer.

Materials to improve the surface tribology performance of the separator may be added. Such materials include lubricants. Lubricants include, for example, fluoropolymers (e.g., polyvinylidene fluoride, polytetrafluoroethylene, low molecular weight fluoropolymers), slip agents (e.g., oleamide, stearamide, erucamide, Kemamide®, calcium stearate, silicone. Loading rates range from 0.001-10 wt % of the polymer of the layer.

Materials to improve the polymer processing may be added. Such materials include, for example, fluoropolymers, boron nitride, polyolefin waxes. Loading rates range from 100 ppm to 10 wt % of the polymer of the layer.

Materials to improve the flame retardant nature of the membrane may be added. Such materials include, for example, brominated flame retardants, ammonium phosphate, ammonium hydroxide, alumina trihydrate, and phosphate ester.

Materials to facilitate nucleation of the polymer may be added. Such materials include nucleating agents. Nucleating agents include, but are not limited to, sodium benzoate, dibenzylidene sorbitol (DBS) and it chemical derivatives. Loading rates are conventional.

Materials to color the layers may be added. Such colorant materials are conventional.

In the manufacture of the instant battery separator, the polymers may be co-extruded to form a multi-layered, nonporous precursor, and then the precursor is processed to form the micropores. Micropores may be formed by a ‘wet’ process or a ‘dry’ process. The wet process (also referred as: solvent extraction, phase inversion, thermally induced phase separation (TIPS), or gel extraction) generally involves: the addition of a removable material prior to the formation of the precursor, and subsequently removing that material, for example, by an extraction process to form the pores. The dry process (also referred to as the Celgard process) generally involves: extruding a precursor (not including any removal material for pore formation); annealing the precursor, and stretching the precursor to form the micropores. The instant invention will be discussed hereinafter with regard to the dry process.

One way to describe the possibly preferred penta-layer structure is an inverted tri-layer (PE/PP/PE) laminated between two polypropylene layers:

### Exemplary Additional Data Thereon

In accordance with at least selected embodiments, aspects, or objects, the application, disclosure, or invention relates to improved membranes, separator membranes, separators, battery separators, secondary lithium battery separators, multilayer membranes, multilayer separator membranes, multilayer separators, multilayer battery separators, multilayer secondary lithium battery separators, multilayer battery separators, batteries, capacitors, super capacitors, double layer super capacitors, fuel cells, lithium batteries, lithium ion batteries, secondary lithium batteries, and/or secondary lithium ion batteries, and/or methods for making and/or using such membranes, separator membranes, separators, battery separators, secondary lithium battery separators, batteries, capacitors, fuel cells, lithium batteries, lithium ion batteries, secondary lithium batteries, and/or secondary lithium ion batteries, and/or devices, vehicles or products including the same, and/or the like.

In accordance with at least selected embodiments, the application, disclosure or invention relates to improved membranes, separator membranes, separators, battery separators, secondary lithium battery separators, multilayer membranes, multilayer separator membranes, multilayer separators, multilayer battery separators, multilayer secondary lithium battery separators, multilayer battery separators, electrochemical cells, batteries, capacitors, super capacitors, double layer super capacitors, fuel cells, lithium batteries, lithium ion batteries, secondary lithium batteries, and/or secondary lithium ion batteries, and/or methods for making and/or using such membranes, separator membranes, separators, battery separators, secondary lithium battery separators, electrochemical cells, batteries, capacitors, fuel cells, lithium batteries, lithium ion batteries, secondary lithium batteries, and/or secondary lithium ion batteries, and/or devices, vehicles or products including the same, and/or the like.

Various embodiments of the invention have been described in fulfillment of the various objects of the invention. It should be recognized that these embodiments are merely illustrative of the principles of the invention. Numerous modifications and adaptations will be readily apparent to those skilled in the art without departing from the spirit and scope of this invention.

As used in the specification and the appended claims, the singular forms “a,” “an,” and “the” include plural referents unless the context clearly dictates otherwise. Ranges can be expressed herein as from “about” or “approximately” one particular value, and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. “Optional” or “optionally” means that the subsequently described event or circumstance can or cannot occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers, or steps. The terms “consisting essentially of” and “consisting of” can be used in place of “comprising” and “including” to provide for more specific embodiments of the invention and are also disclosed. “Exemplary” or “for example” means “an example of” and is not intended to convey an indication of a preferred or ideal embodiment. Similarly, “such as” is not used in a restrictive sense, but for explanatory or exemplary purposes.

Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

1-59. (canceled)

60. A microporous membrane comprising:
two outer layers, each outer layer comprising a polyolefin; and
a plurality of inner layers, each inner layer comprising a polyolefin;
wherein each of the outer layers is laminated to an inner layer and each of the plurality of inner layers is laminated to at least one other inner layer.

61. The microporous membrane of claim 60, wherein the each of the outer layers comprises a polypropylene, a polypropylene blend, a polypropylene copolymer, a polyethylene, a polyethylene blend, a polyethylene copolymer, or any combination thereof.

62. The microporous membrane of claim 60, wherein each outer layer comprises a polypropylene, a polypropylene blend, a polypropylene copolymer, or any combination thereof.

63. The microporous membrane of claim 60, wherein the each of the plurality of inner layers comprises a polypropylene, a polypropylene blend, a polypropylene copolymer, a polyethylene, a polyethylene blend, a polyethylene copolymer, or any combination thereof.

64. The microporous membrane of claim 60, wherein there are two, three, four, five, six or more inner layers.

65. The microporous membrane of claim 60, wherein there are three inner layers.

66. The microporous membrane of claim 60, wherein microporous membrane is a penta-layered membrane comprising a first outer layer, a first inner layer, a second inner (or middle) layer, a third inner layer, and a second outer layer.

67. The microporous membrane of claim 66, wherein
the first outer layer is laminated to the first inner layer;
the first inner layer is laminated to the first outer layer and the second inner (or middle) layer;
the second inner (or middle) layer is laminated to the first inner layer and the third inner layer;
and the third inner is laminated to the second inner (or middle) layer and the second outer layer.

68. The microporous membrane of claim 66, wherein the first and second outer layers and the second inner (or middle) layer comprise a polypropylene, a polypropylene blend, a polypropylene copolymer, or any combination thereof.

69. The microporous membrane of claim 68, wherein the first and third inner layers comprise a polyethylene, a polyethylene blend, a polyethylene copolymer, or any combination thereof.

70. The microporous membrane of claim 60, wherein the microporous membrane comprises a penta-layered membrane comprising a structure of PP/PE/PP/PE/PP, where PP is a polypropylene, a polypropylene blend, a polypropylene copolymer, or any combination thereof, and PE is a polyethylene, a polyethylene blend, a polyethylene copolymer, or any combination thereof.

71. The microporous membrane of claim 70, wherein each of the five layers (inner or outer) of the penta-layered membrane is laminated to their respective adjacent layers (inner or outer).

72. The microporous membrane of claim 60, wherein:
each layer (inner or outer) comprises two, three, four, five, or more sublayers.
each layer (inner or outer) comprises two, three, or more sublayers;
each layer (inner or outer) comprises three sublayers;
each layer (inner or outer) comprises three sublayers, wherein each sublayer has a maximum average thickness of 6 μm or less, 5 μm or less, 4 μm or less, 3 μm or less, 2 μm or less, or 1 □m or less;
the membrane has a maximum average thickness ranging from 1 to 50 microns
each layer comprises a maximum average thickness of 33%, 32%, 31%, 30%, 29%, 28%, or less that 28% of a total average thickness of the membrane;
the membrane has been machine direction stretched;
the membrane has been transverse direction stretched;
the membrane has been machine direction stretched and transverse direction stretched;
the microporous membrane has been transverse direction stretched and calendered;
the membrane further comprises an additive;
the membrane further comprises an additive, wherein the additive comprises a functionalized polymer, an ionomer, a cellulose nanofiber, an inorganic particle, a lubricating agent, a nucleating agent, a cavitation promoter, a fluoropolymer, a cross-linker, a x-ray detectable material, a polymer processing agent, a high temperature melt index (NTMI) polymer, an electrolyte additive, an energy dissipative non-miscible additive, or any combination thereof; or
the membrane comprises an additive, wherein the additive is a coating on the first outer layer, the second outer layer, or both the first and second layers.

73. The microporous membrane of claim 72, wherein each of the sublayers is coextruded, an optionally wherein each layer has a maximum average thickness of 1.2 mil or less, 1.1 mil or less, 1 mil or less, or 0.9 mil or less 0.8 mil or less, 0.75 mil or less, 0.5 mil or less, 0.4 mil or less, 0.3 mil or less, or 0.2 mil or less prior to stretching.

74. The microporous membrane of claim 68, wherein: the first and second outer layers and the second inner (or middle) layer have an average polypropylene pore size in the range of 0.02 and 0.06 μm; or
the first and third inner layers have an average polyethylene pore size in the range of 0.03 to 1.0 μm.

75. The microporous membrane of claim 60, wherein:
the membrane has an increased or improved elasticity at or above 150° C. compared to a PP/PE/PP tri-layer microporous membrane having the same thickness, Gurley, porosity, and/or layer composition make-up as the membrane;
the membrane has an increased or improved puncture resistance compared to a PP/PE/PP tri-layer microporous membrane having the same thickness, Gurley, porosity, and/or layer composition make-up as the membrane;
the membrane has an increased or improved machine direction tensile at break compared to a PP/PE/PP tri-layer microporous membrane having the same thickness, Gurley, porosity, and/or layer composition make-up as the membrane; or
the membrane has an increased or improved TD elongation compared to a PP/PE/PP tri-layer microporous membrane having the same thickness, Gurley, porosity, and/or layer composition make-up as the membrane.

76. In a lithium ion battery, a device, or a textile, the improvement comprising the microporous membrane of claim 60.

77. A method of making a multilayer microporous membrane, the method comprising:
extruding a polypropylene precursor comprising a plurality of sublayers;
extruding a polyethylene precursor comprising a plurality of sublayers;
laminating the extruded polypropylene precursor layers with the extruded polyethylene precursor layers to form a first intermediate precursor having an alternating polyethylene and polypropylene precursors structure;
simultaneously or singly laminating a first outer layer comprising one of the extruded polypropylene precursors to a first surface of the intermediate precursor and a second outer layer comprising one of the extruded polypropylene precursors to a second surface of the first intermediate precursor opposite the first surface to form a second intermediate precursor;
annealing the second intermediate precursor to form an annealed multilayer membrane;
stretching the annealed multilayer membrane to form a microporous multilayer membrane, wherein the stretching is uniaxial or biaxial; and
optionally calendering the microporous multilayer membrane.

78. The method of claim 77, wherein:
the first intermediate precursor comprises a trilayer structure of PE/PP/PE or PP/PE/PP or a four-layer structure of PP/PE/PE/PP or PE/PP/PP/PE;
the second intermediate precursor comprises a penta-layer structure of PP/PE/PP/PE/PP or PE/PP/PE/PP/PE or a six-layer structure of PP/PP/PE/PE/PP/PP, PE/PE/PP/PP/PE/PE, PP/PE/PE/PE/PE/PP, or PE/PP/PP/PP/PP/PE;
the uniaxial stretching is in the machine direction or the transverse direction;
the biaxial stretching is in the machine direction and transverse direction;
the biaxial stretching is in the machine direction and transverse direction, wherein the machine direction and transverse direction stretching is sequential or simultaneous;
the extruded polypropylene precursor comprises two, three, four, or more sublayers;
the extruded polyethylene precursor comprises two, three, four, or more sublayers;
the second intermediate precursor comprises a penta-layer structure of PP/PE/PP/PE/PP, where each of the polyethylene and polypropylene precursors comprises three sublayers; or
the extruded polypropylene precursor and the extruded polyethylene precursor are nonporous.

79. The method of claim 78, further comprising the step of coating one or more of the first outer layer and the second outer layer.

80. A method for making a penta-layer microporous membrane comprising:
extruding a plurality of polypropylene membranes and polyethylene membranes;
laminating one of the polyethylene membranes to a first side of a polypropylene membrane and another one of the polyethylene membranes to an opposite second side of the polypropylene membrane to form an inverted trilayer membrane having a structure of PE/PP/PE;
simultaneously or singly laminating one of the polypropylene layers to one of the polyethylene membranes in the inverted trilayer membrane and another of the polypropylene layers to the other polyethylene membrane in the inverted trilayer membrane to form a penta-layer membrane having a structure of PP/PE/PP/PE/PP;
annealing the penta-layer membrane; and
stretching the annealed penta-layer membrane to form the microporous membrane, wherein the stretching is uniaxial or biaxial or stretching and optionally calendering the annealed penta-layer membrane to form the microporous multilayer membrane.

81. A battery separator, a lithium ion battery separator, a device, or a textile comprising the microporous membrane formed by the method of claim 78.

82. A multilayer microporous membrane comprising three or more lamination interfaces and exhibiting a puncture strength of 150 g or more 260 g or more, 270 g or more, 280 g or more, 290 g or more, 300 g or more, 310 g or more, 400 g or more, or 500 g or more.

83. The membrane of claim 82, comprising three lamination interfaces; comprising four lamination surfaces; or comprising five or more lamination surfaces.

84. The membrane of claim 82, wherein the membrane comprises four or more layers, each layer comprising two or more sublayers formed by a co-extrusion process.

85. In a electrochemical cell, battery, capacitor, super capacitor, double layer super capacitor, fuel cell, lithium battery, lithium ion battery, secondary lithium battery, and/or secondary lithium ion battery the improvement comprising the microporous membrane of claim 60.
